(19) United States
(12) Patent Application Publication
(10) Pub. No.: US 2026/0086307 A1
(43) Pub. Date: Mar. 26, 2026

(54) OPTICAL COUPLING USING SHIFTED OUT-OF-PLANE LIGHT PROPAGATION

(71) Applicant: Intel Corporation, Santa Clara, CA (US)

(72) Inventors: Georgios C. Dogiamis, Chandler, AZ (US); Henning Braunisch, Phoenix, AZ (US); Adel Elsherbini, Chandler, AZ (US); Nada J. Sekeljic, Hillsboro, OR (US); Brandon M. Rawlings, Chandler, AZ (US); Feras Eid, Chandler, AZ (US); James E. Jaussi, El Dorado Hills, CA (US); Haisheng Rong, Pleasanton, CA (US); Veronica Strong, Hillsboro, OR (US); Johanna Swan, Scottsdale, AZ (US)

(73) Assignee: Intel Corporation, Santa Clara, CA (US)

(21) Appl. No.: 18/897,152

(22) Filed: Sep. 26, 2024

(51) Int. Cl. G02B 6/42; G02B 6/30; G02B 6/36

(52) U.S. Cl. CPC G02B 6/4298; G02B 6/305; G02B 6/3636; G02B 6/4214; G02B 6/4215; G02B 6/4291

(57) ABSTRACT

Devices and systems with shifted out-of-plane light propagation, and methods of forming the same, are disclosed herein. In one example, a microelectronic assembly includes a first optical waveguide, a second optical waveguide, and one or more passive optical components. The first and second optical waveguides are optically coupled via the passive optical components. Moreover, the passive optical components are to shift light propagation out of plane between the first and second optical waveguides.

### BACKGROUND

In some cases, a photonic integrated circuit (PIC) may be used to send and receive optical signals over an array of optical fibers. This requires the PIC to be optically coupled to the fibers, either directly or indirectly, which in turn requires precise alignment between the PIC, the optical fibers, and any intervening components used to optically couple the PIC to the optical fibers. Due to the strict alignment requirements, a PIC often includes v-grooves or other alignment features to help align the optical fibers with the waveguides in the PIC. V-grooves and other alignment features can be difficult to manufacture, however, as they are typically relatively deep structures with highly controlled slopes. Moreover, the v-grooves must be deep enough to accommodate the fibers, and the PIC must be thick enough to accommodate the v-grooves, which means the depth of the v-grooves drives the thickness of the PIC. As a result, the PIC may need to be relatively thick to accommodate deep v-grooves, which can lead to challenges when integrating the PIC into a chip.

### BRIEF DESCRIPTION OF THE DRAWINGS

FIGS. 1A-C illustrate a microelectronic assembly that uses vertical couplers and mirrors for shifted out-of-plane light propagation.

FIG. 2 illustrates a cross-section view of another microelectronic assembly that uses vertical couplers and mirrors for shifted out-of-plane light propagation.

FIG. 3 illustrates a cross-section view of a microelectronic assembly that uses lateral couplers and spot size converters for shifted out-of-plane light propagation.

FIG. 4 illustrates a cross-section view of another microelectronic assembly that uses lateral-to-lateral couplers and spot size converters for shifted out-of-plane light propagation.

FIGS. 5A-B illustrate cross-section views of a microelectronic assembly that uses vertical couplers and a structural substrate with embedded mirrors for shifted out-of-plane light propagation.

FIG. 6 illustrates a cross-section view of another microelectronic assembly that uses vertical couplers and a structural substrate with embedded mirrors for shifted out-of-plane light propagation.

FIG. 7 illustrates an example of a microelectronic assembly with shifted out-of-plane light propagation between multiple semiconductor chips.

FIG. 8 illustrates an example of a microelectronic assembly with shifted out-of-plane light propagation between a semiconductor chip and an optical connector via a one-dimensional waveguide array.

FIG. 9 illustrates an example of a microelectronic assembly with shifted out-of-plane light propagation between a semiconductor chip and an optical connector via a two-dimensional waveguide array.

FIGS. 10A-J illustrate a process flow for forming substrates with embedded mirrors.

FIGS. 11A-C illustrate cross-section views of various configurations of microelectronic assemblies with out-of-plane light propagation.

FIG. 12 illustrates a process flow for forming microelectronic assemblies with out-of-plane light propagation in accordance with certain embodiments.

FIG. 13 illustrates a top view of a wafer and dies.

FIG. 14 illustrates a cross-sectional side view of an integrated circuit device assembly.

FIG. 15 illustrates a block diagram of an example electronic device.

### DETAILED DESCRIPTION

High-speed optical interconnects are crucial to meet the continuously increasing data rate demands of modern data centers and computing systems. In particular, traditional computing components (e.g., processors, accelerators, FPGAs, switches, memory/storage, other ASIC nodes) can be packaged with optical interfaces to enable them to communicate over high-speed optical interconnects rather than traditional electrical interconnects. For example, an optical interface may include one or more photonic devices, such as a photonic integrated circuit (PIC) and/or an optical interposer, to send and receive light beams over an array of optical fibers. This requires the photonic devices to be optically coupled to the fibers, either directly or indirectly, which in turn requires precise alignment between the photonic devices, the optical fibers, and/or any intervening components used to optically couple the photonic devices to the optical fibers.

Due to the strict alignment requirements, photonic devices often include alignment features, such as v-grooves, to help align optical fibers (or other optical components) with the waveguides in the photonic devices. V-grooves and other alignment features can be difficult to manufacture in photonic substrates, however, as they typically require relatively deep structures with highly controlled slopes to be patterned in the substrates. Moreover, the depth of the grooves drives the thickness of the photonic wafers, as photonic devices must be thicker than the depth of the grooves. In some cases, for example, a photonic device may have grooves with a depth of about 70μm to accommodate fibers with a diameter of 125μm or more, which may require the photonic device to have a thickness of 100 μm or more to accommodate the grooves. For highly-disaggregated quasi-monolithic chips, however, thick photonic devices may lead to incompatibilities relating to thin die integration and photonic chip-to-chip links. For example, in stacked three-dimensional (3D) configurations, stacked dies typically need to be relatively thin to reduce parasitics, such as around 50μm thick, which makes it challenging to integrate photonic devices with a thickness of 100μm or more.

Accordingly, this disclosure presents embodiments of devices and systems with shifted out-of-plane light propagation using passive optical components, along with methods of forming the same. In some embodiments, for example, passive optical components (e.g., grating couplers, evanescent couplers, mirrors, waveguides, spot size converters, mode size converters, lenses) are used to shift or redirect light propagation out of plane over the surface of a photonic device, such as a PIC or an optical interposer. As a result, the optical fibers attached to the photonic device are shifted higher up to align the fiber cores with the higher out-of-plane light beams above the surface of the photonic device. In this manner, shifting up the fibers enables the depth of the fiber v-grooves in the photonic device to be reduced, and in turn, the shallower v-grooves enable the thickness of the photonic device to be reduced. Moreover, shallower v-grooves are also easier to manufacture, which leads to better manufacturability and process control.

The described embodiments may provide various advantages, including shallower groove structures in photonic devices for optical alignment (e.g., shallower v-grooves for fiber alignment), reduced thickness of the photonic device due to the shallower grooves, better manufacturability and process control due to the easier fabrication process for the shallower grooves, the ability to integrate the photonic solution in a quasi-monolithic manner for advanced packaging architectures (e.g., 3D stacked heterogenous integration), the ability to implement multi-dimensional light coupling arrays in photonic devices, and support for optical coupling between any optical components, including chip-to-fiber, chip-to-chip, and chip-to-connector (to fiber array unit (FAU)) optical coupling.

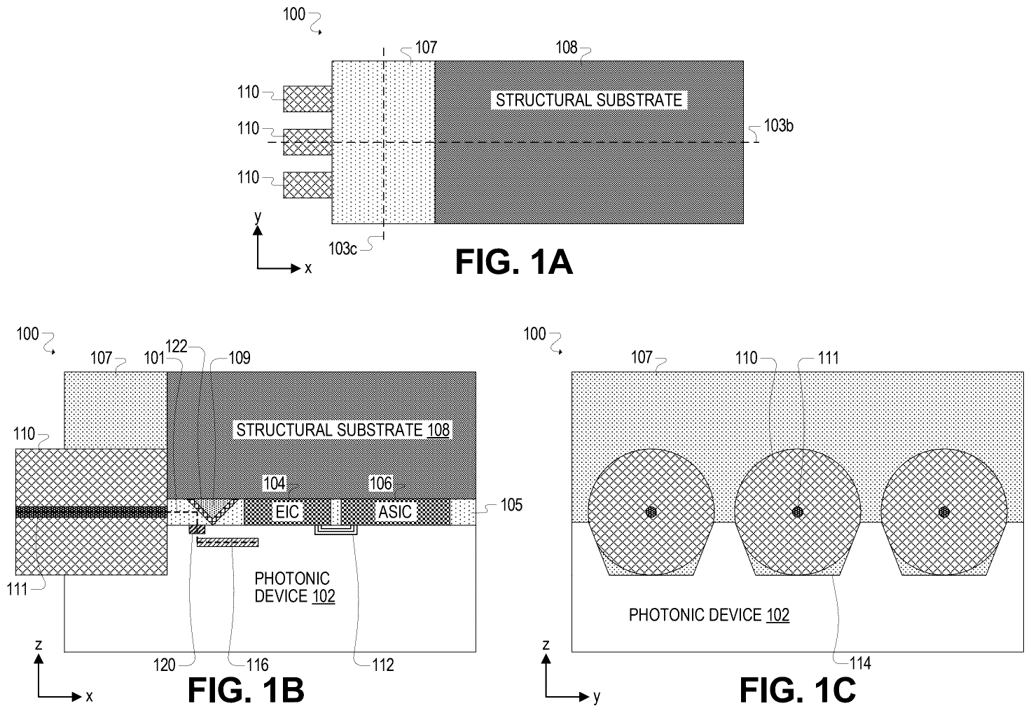

FIGS. 1A-C illustrate an example of a microelectronic assembly 100 that uses vertical couplers 120 and mirrors 122 for shifted out-of-plane light propagation. In particular, FIG. 1A shows a plan view (x-y plane) of microelectronic assembly 100, and FIGS. 1B and 1C show cross-section views (x-z plane and y-z plane, respectively) of microelectronic assembly 100. The cut lines 103b,c for the respective cross-section views of FIGS. 1B and 1C are shown in the plan view of FIG. 1A.

In the illustrated embodiment, microelectronic assembly 100 includes a photonic device 102, an electronic integrated circuit (EIC) 104 and an application-specific integrated circuit (ASIC) 106 attached and electrically coupled to the frontside of the photonic device 102 (and electrically coupled to each other via an electrical interconnect 112), and a structural substrate 108 attached over the EIC 104 and the ASIC 106. Moreover, an array of optical (e.g., glass) fibers 110 is attached to the edge of the photonic device 102, where the ends of the respective fibers 100 are inserted in v-grooves 114 on the surface of the photonic device 102.

The photonic device 102 may include any type or combination photonic devices, components, or dies, such as a photonic integrated circuit (PIC), an optical interposer, an optical/electrical interposer, or a combination of any of the foregoing components along with other electrical components (e.g., a PIC or optical interposer and an electrical interposer). The EIC 104 may include circuitry to control or drive the photonic device 102 (or alternatively, a PIC connected to the photonic device 102). The ASIC 106 may include any type of integrated circuit (e.g., CPUs, GPUs, FPGAs) that uses the EIC 104 and the photonic device 102 to communicate optically with other components (not shown) via the attached fibers 110. The structural substrate 108 may be any suitable type of substrate (e.g., a relatively thick silicon substrate) attached on top of the microelectronic assembly 100 to provide thermomechanical benefits (e.g., improved structural and mechanical integrity).

In the illustrated embodiment, photonic waveguides 116 in the photonic device 102 are optically coupled to the cores 111 of the respective fibers 110 via a set of passive optical components (e.g., vertical couplers 120, mirrors 122), which are used to shift or redirect light propagation 101 out of plane into a propagation layer 105 above the surface of the photonic device 102. In this manner, the fibers 110 are shifted higher up vertically to align the fiber cores 111 with the out-of-plane light beams 101 in the propagation layer 105, which enables the depth of the fiber v-grooves 114 in the photonic device 102 to be reduced. In turn, the shallower v-grooves 114 enable the thickness of the photonic device 102 to be reduced (e.g., by roughly the same amount as the distance in which the fibers 110 are shifted up). In some embodiments, for example, the fibers 110 may be shifted up by a distance ranging from 10-50μm, which results in corresponding reductions in v-groove 114 depth and photonic device 102 thickness. Shallower v-grooves 114 are also easier to manufacture and make it easier to control a tighter process tolerance.

In the illustrated embodiment, for example, light propagates along the following path 101 through microelectronic assembly 100: photonic waveguide 116 to vertical (e.g., grating) coupler 120 to mirror 122 to fiber core 111 (and vice versa). For example, when a light beam 101 is transmitted from the photonic device 102 to one of the fibers 110, the beam 101 propagates horizontally through a waveguide 116 of the photonic device 102 to a vertical coupler 120, such as a grating coupler. The vertical coupler 120 redirects the light beam 101 by an angle of about 90 degrees, which changes the beam's direction of propagation from horizontal to vertical, causing the beam 101 to be emitted vertically from the top surface or frontside of the photonic device 102. As a result, the light beam 101 propagates vertically into the mirror 122 in the propagation layer 105, which reflects the beam 101 at an angle of about 90 degrees, causing the beam's direction of propagation to change from vertical back to horizontal. The light beam then propagates horizontally—out of plane and above the surface of the photonic device 102—into the core 111 of the corresponding fiber 110. When a light beam 101 is transmitted in the reverse direction (e.g., from one of the fibers 110 to the photonic device 102), the path of light propagation 101 flows in the reverse order.

The vertical couplers 120 may include any type of optical couplers for redirecting light propagation roughly 90 degrees (e.g., from horizontal to vertical propagation and vice versa). In some embodiments, for example, the vertical couplers 120 may include grating couplers, which use diffraction gratings to redirect light at certain angles. In particular, a diffraction grating may include a series of periodic structures etched or patterned on a surface, which causes light to diffract at a particular angle based on the design of the grating (e.g., grating period, wavelength, refractive indices). In this manner, grating couplers 120 may be used to redirect light in and out of the photonic waveguides 116 at an angle of roughly 90 degrees, thus changing the direction of propagation from horizontal to vertical and vice versa. In some embodiments, the grating couplers 120 may be patterned in dielectric materials (e.g., silicon nitride (SiN)).

The mirrors 122 may include any type of structures capable of reflecting light at a particular angle, such as an angle of roughly 90 degrees. In general, mirrors 122 may be formed by the interface of two materials with different refractive indices (e.g., materials with low and high refractive indices). In the illustrated embodiment, the mirrors 122 are monolithically fabricated or patterned in the propagation layer 105, and the area inside the mirrors 122 is filled with a dielectric material 109. The mirrors 122 may be made of any suitable reflective material capable of reflecting light of the requisite wavelengths for a given application, such as smooth polished metals (e.g., titanium, copper, aluminum) or semiconductors (e.g., silicon), among other examples.

The out-of-plane light propagation layer 105, along with adjacent layers 107 through which light may also propagate, may be filled with index-matching materials that are transparent to light, such as glass, silicon, or other light-transparent dielectrics (e.g., oxides such as SiO₂). In particular, index-matching materials are materials with the same or similar refractive index, which reduces reflections and losses at the interfaces between the materials and enables light to propagate between them efficiently. In some embodiments, the light propagation layer 105 may have a thickness in the range of 10-50μm.

Throughout this disclosure, the term microelectronic assembly may refer to one or more chips, quasi-monolithic chips (QMCs), integrated circuits (IC), IC devices, IC packages, IC assemblies, semiconductor devices, and/or electronic devices or systems, or any other assembly of microelectronic components.

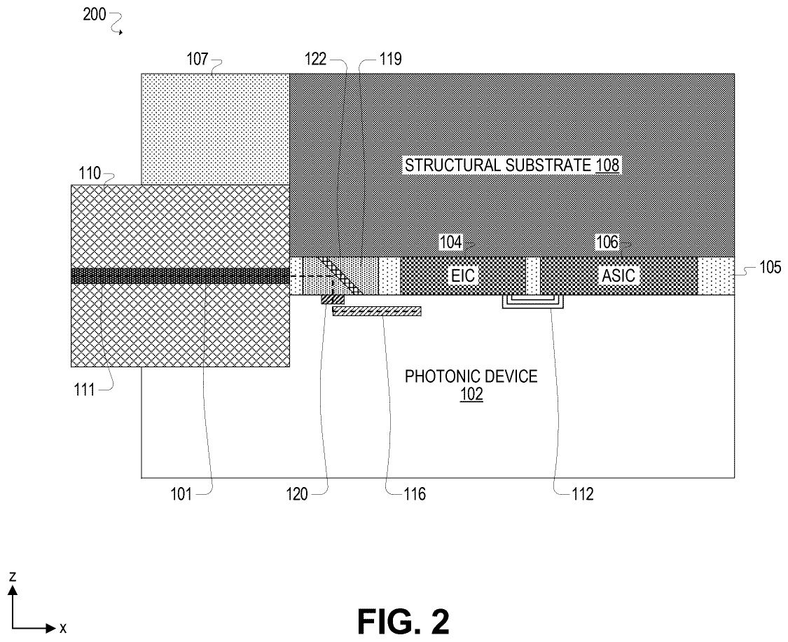

FIG. 2 illustrates a cross-section view (x-z plane) of another microelectronic assembly 200 that uses vertical couplers 120 and mirrors 122 for shifted out-of-plane light propagation. In the illustrated embodiment, microelectronic assembly 200 is similar to microelectronic assembly 100, except the mirrors 122 are fabricated separately in an external standalone device 119, which is subsequently integrated into microelectronic assembly 200, instead of being fabricated monolithically in the propagation layer 105.

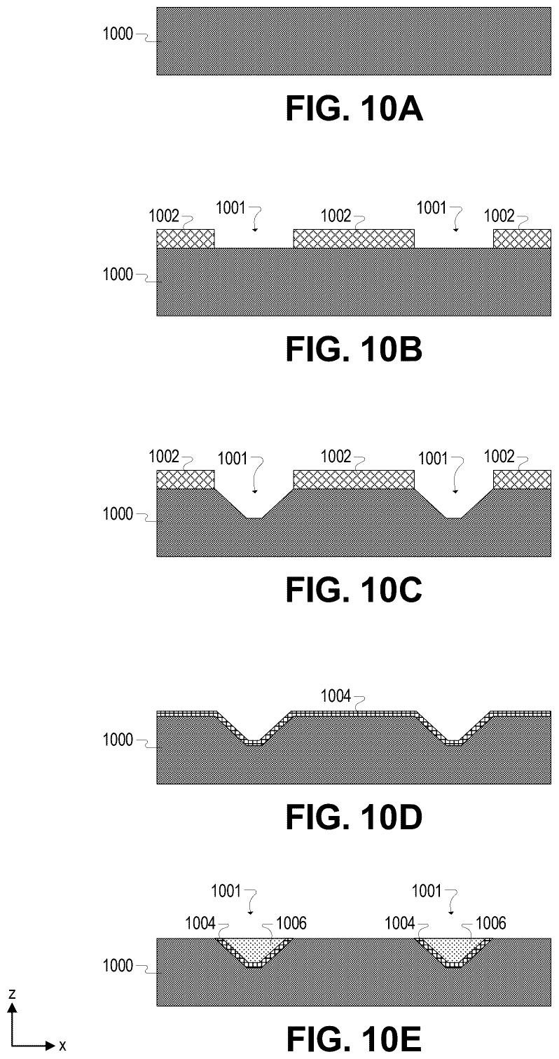

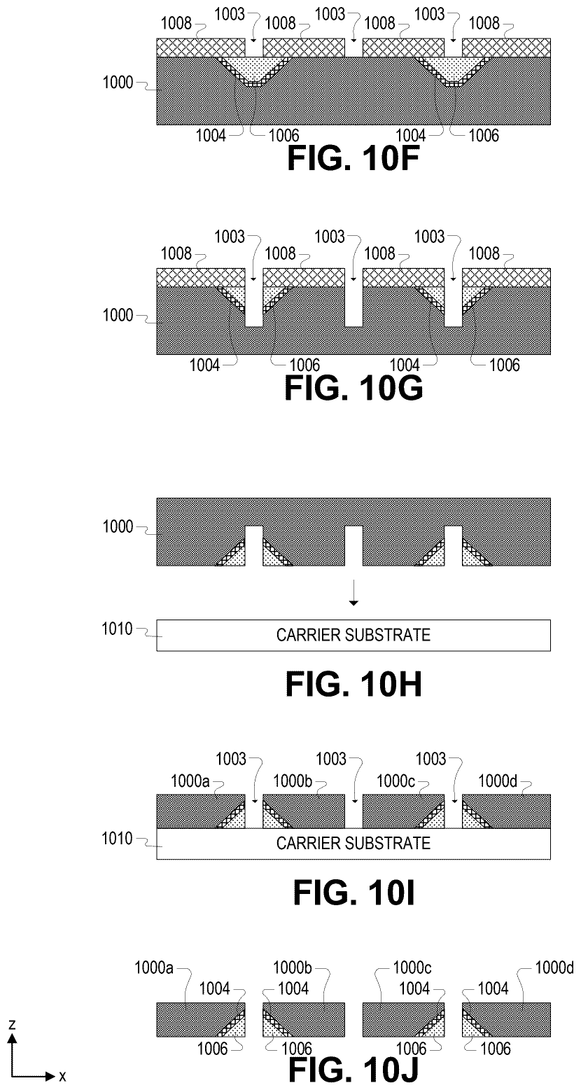

In particular, a passive optical device 119 with one or more embedded mirrors 122 is fabricated in a separate process, and the passive device 119 is subsequently integrated into microelectronic assembly 200 during the assembly process. In some embodiments, for example, the mirrors 122 may be embedded in a light-transparent index-matching material or substrate 119 (e.g., a material that is transparent to light and has a similar refractive index as surrounding layers such as propagation layer 105), such as glass, silicon, or light-transparent dielectrics. For example, the mirrors 122 may be patterned in a glass or silicon substrate/die 119 (e.g., using the process flow of FIGS. 10A-J). In some embodiments, the passive optical device 119 may have a thickness in the range of 10-50μm. Moreover, during fabrication of microelectronic assembly 200, the external passive device 119 may be assembled on top of the photonic device 102 (e.g., bonded to the surface of the photonic device 102 above the vertical couplers 120 utilizing fusion bonding, thermocompression bonding, hybrid bonding, pick-and-place assembly, etc.).

Since the passive optical device 119 is fabricated in a separate process, it is not subject to the same design rules and constraints (e.g., thermal constraints) imposed by the fabrication process used for microelectronic assembly 200. As a result, this approach provides greater flexibility for material selection, including the selection of materials for the mirror 122 and the index-matching material 119 (e.g., providing more precise control over refraction indices), the use of anti-reflective coatings, etc.

While the external passive device 119 includes mirrors 122 in the illustrated embodiment, the external passive device 119 may include any type or combination of passive optical components in other embodiments (e.g., mirrors, optical couplers, waveguides, edge launchers, vertical launchers, beam shapers, etc.). Moreover, in some embodiments, microelectronic assembly 200 may include some passive optical components that are fabricated monolithically and some that are fabricated separately in one or more external standalone devices.

In the illustrated embodiment, light propagates along the following path 101 through microelectronic assembly 200: photonic waveguide 116 to vertical (e.g., grating) coupler 120 to integrated mirror 122 to fiber core 111 (and vice versa). For example, when a light beam is transmitted from the photonic device 102 to one of the fibers 110, the beam propagates horizontally through a waveguide 116 of the photonic device 102 to a vertical coupler 120. The vertical coupler 120 redirects the light beam by an angle of about 90 degrees, which changes the beam's direction of propagation from horizontal to vertical, causing the beam to be emitted vertically from the top surface or frontside of the photonic device 102. As a result, the light beam propagates vertically into the integrated mirror 122 of the external passive device 119, which reflects the beam at an angle of about 90 degrees, causing the beam's direction of propagation to change from vertical back to horizontal. The light beam then propagates horizontally—out of plane and above the surface of the photonic device 102—into the core 111 of the corresponding fiber 110. When a light beam is transmitted in the reverse direction (e.g., from one of the fibers 110 to the photonic device 102), the path of light propagation 101 flows in the reverse order.

In this manner, a light beam propagating horizontally in one of the waveguides 116 of the photonic device 102 is shifted vertically, or out of plane of the photonic device 102, such that the beam propagates horizontally above the surface of the photonic device 102 (e.g., instead of propagating horizontally through the photonic device 102 and being emitted from the edge of the photonic device 102). As a result, the fibers 110 are repositioned, or shifted up, to align the fiber cores 111 with the out-of-plane light beams, which enables the depth of the fiber v-grooves 114 in the photonic device 102 to be reduced. In turn, the shallower v-grooves 114 enable the thickness of the photonic device 102 to be reduced (e.g., by roughly the same amount as the distance in which the fibers 110 are shifted up).

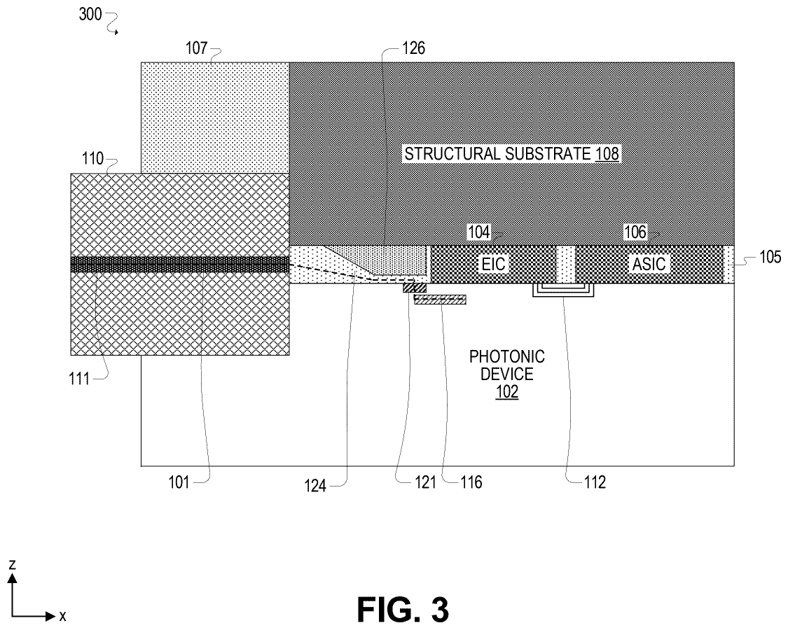

FIG. 3 illustrates a cross-section view (x-z plane) of a microelectronic assembly 300 that uses lateral couplers 121 and spot size converters 124 for shifted out-of-plane light propagation. In the illustrated embodiment, microelectronic assembly 300 is similar to microelectronic assembly 100, except the photonic device 102 includes lateral-to-lateral couplers 121 (e.g., evanescent couplers) instead of vertical couplers 120, and the propagation layer 105 includes spot size converters 124 instead of mirrors 122.

Lateral-to-lateral couplers 121, also referred to herein as lateral couplers, are used to optically couple light between multiple optical waveguides that are adjacent or in close proximity. In some embodiments, for example, the lateral couplers 121 may be implemented as evanescent couplers (EVCs). Evanescent couplers are designed to transfer light between two closely-spaced waveguides through evanescent fields. In particular, when light is confined in an optical waveguide, some of the light penetrates slightly outside the waveguide in the form of evanescent fields. If a second waveguide is placed in close proximity to the first waveguide, the evanescent fields from the first waveguide overlap with the second waveguide, which enables the light to “couple” from the first waveguide to the second waveguide without the need for direct contact or physical joining.

Spot size converters 124 (SSCs) are used to transform the size of the optical mode —referred to as the “mode size” or “spot size” in one waveguide to match the size of the optical mode in another waveguide. In this manner, waveguides with different mode field diameters (MFDs) can be optically coupled more efficiently using spot size converters 124 to match their spot sizes, which minimizes loss and reflection and relaxes the alignment requirements. In particular, aligning the core 111 (e.g., 5-10μm diameter) of a relatively large fiber 110 with a much smaller photonic waveguide 116 (e.g., 0.5-2μm diameter) can be challenging, but spot size converters 124 can be used to relax the strict alignment requirements.

In the illustrated embodiment, one or more spot size converters (SSCs) 124 are monolithically fabricated in the propagation layer 105. In particular, the light-transparent dielectric material in the propagation layer 105 (e.g., fill oxide such as SiO₂) is patterned into a spot size converter structure 124, which is a tapered waveguide structure that gradually transitions in diameter between a narrower end and a wider end. Moreover, the portion of the propagation layer 105 that was removed to pattern the SSC 124 is filled with an index-mismatched material 126—a material with a different (e.g., lower) refractive index than the spot size converter 124—to confine light within the spot size converter 124. In this manner, when a light beam propagates through the spot size converter 124, the mode field diameter of the light beam gradually increases or decreases depending on the direction of propagation. In some embodiments, the spot size converters 126 may have a thickness in the range of 10-50μm (e.g., the same thickness as the fill oxide in the propagation layer 105).

In the illustrated embodiment, light propagates along the following path 101 through microelectronic assembly 300: photonic waveguide 116 to lateral (e.g., evanescent) coupler 121 to spot size converter 124 to fiber core 111 (and vice versa). For example, when a light beam is transmitted from the photonic device 102 to one of the fibers 110, the beam propagates horizontally through a waveguide 116 of the photonic device 102 towards a lateral coupler 121. The lateral coupler 121 transfers the light beam from the photonic waveguide 116 into the adjacent spot size converter (SSC) 124 in the propagation layer 105, which causes the beam to propagate horizontally through the SSC 124 (e.g., out-of-plane and above the surface of the photonic device 102). As the light beam propagates from the narrower end to the wider end of the SSC 124, the spot size of the light beam expands (and contracts when the beam propagates in the opposite direction), and the expanded beam propagates into the core 111 of the corresponding fiber 110. When a light beam is transmitted in the reverse direction (e.g., from one of the fibers 110 to the photonic device 102), the path of light propagation 101 flows in the reverse order.

In this manner, a light beam propagating horizontally in a waveguide 116 of the photonic device 102 is shifted vertically, or out of plane of the photonic device 102, such that the beam propagates horizontally above the surface of the photonic device 102 (e.g., instead of propagating horizontally through the photonic device 102 and being emitted from the edge of the photonic device 102). As a result, the fibers 110 are repositioned, or shifted up, to align the fiber cores 111 with the out-of-plane light beams, which enables the depth of the fiber v-grooves 114 in the photonic device 102 to be reduced. In turn, the shallower v-grooves 114 enable the thickness of the photonic device 102 to be reduced (e.g., by roughly the same amount as the distance in which the fibers 110 are shifted up).

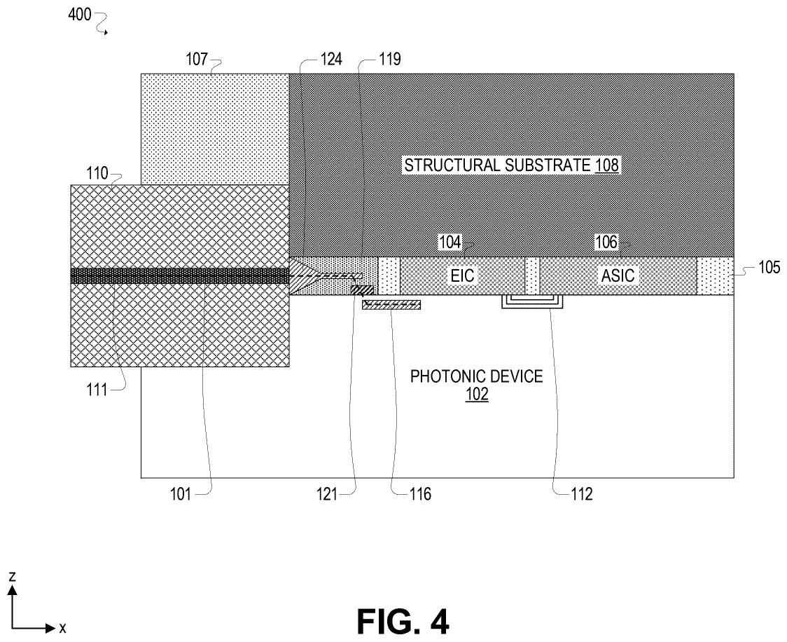

FIG. 4 illustrates a cross-section view (x-z plane) of another microelectronic assembly 400 that uses lateral-to-lateral couplers 121 and spot size converters 124 for shifted out-of-plane light propagation. In the illustrated embodiment, microelectronic assembly 400 is similar to microelectronic assembly 300, except the lateral couplers 121 and the spot size converters 124 are fabricated separately in an external standalone device 119, which is subsequently integrated into microelectronic assembly 400, instead of being fabricated monolithically in the photonic device 102 and the propagation layer 105, respectively.

In particular, a passive optical device 119 with one or more lateral couplers 121 and spot size converters 124 is fabricated in a separate process, and the passive device 119 is integrated into microelectronic assembly 400 during the assembly process. In some embodiments, for example, lateral couplers 121 and spot size converters 124 may be formed on a substrate (e.g., patterned in layers of silicon oxide and/or silicon nitride on a silicon or glass wafer/panel), and the substrate may be diced into singulated passive dies 119, each of which may include one or more lateral couplers 121 and/or one or more spot size converters 124. In some embodiments, the passive dies 119 may have a thickness in the range of 10-50μm. Moreover, one or more of the passive dies 119 may be integrated into microelectronic assembly 400 via assembly (e.g., bonded on top of the photonic device 102 above one end of the photonic waveguides 116 utilizing fusion bonding, thermocompression bonding, hybrid bonding, pick-and-place assembly, etc.).

In the illustrated embodiment, light propagates along the following path 101 through microelectronic assembly 400: photonic waveguide 116 to integrated lateral (e.g., evanescent) coupler 121 to integrated spot size converter 124 to fiber core 111 (and vice versa). For example, when a light beam is transmitted from the photonic device 102 to one of the fibers 110, the beam propagates horizontally through a waveguide 116 of the photonic device 102 towards an integrated lateral coupler 121 in the external passive device 119. The integrated lateral coupler 121 transfers the light beam from the photonic waveguide 116 into the adjacent spot size converter (SSC) 124, which causes the beam to propagate horizontally through the SSC 124 (e.g., out-of-plane and above the surface of the photonic device 102). As the light beam propagates from the narrower end to the wider end of the SSC 124, the spot size of the light beam expands (and contracts when the beam propagates in the opposite direction), and the expanded beam propagates into the core 111 of the corresponding fiber 110. When a light beam is transmitted in the reverse direction (e.g., from one of the fibers 110 to the photonic device 102), the path of light propagation 101 flows in the reverse order.

In this manner, a light beam propagating horizontally in a waveguide 116 of the photonic device 102 is shifted vertically, or out of plane of the photonic device 102, such that the beam propagates horizontally above the surface of the photonic device 102 (e.g., instead of propagating horizontally through the photonic device 102 and being emitted from the edge of the photonic device 102). As a result, the fibers 110 are repositioned, or shifted up, to align the fiber cores 111 with the out-of-plane light beams, which enables the depth of the fiber v-grooves 114 in the photonic device 102 to be reduced. In turn, the shallower v-grooves 114 enable the thickness of the photonic device 102 to be reduced (e.g., by roughly the same amount as the distance in which the fibers 110 are shifted up).

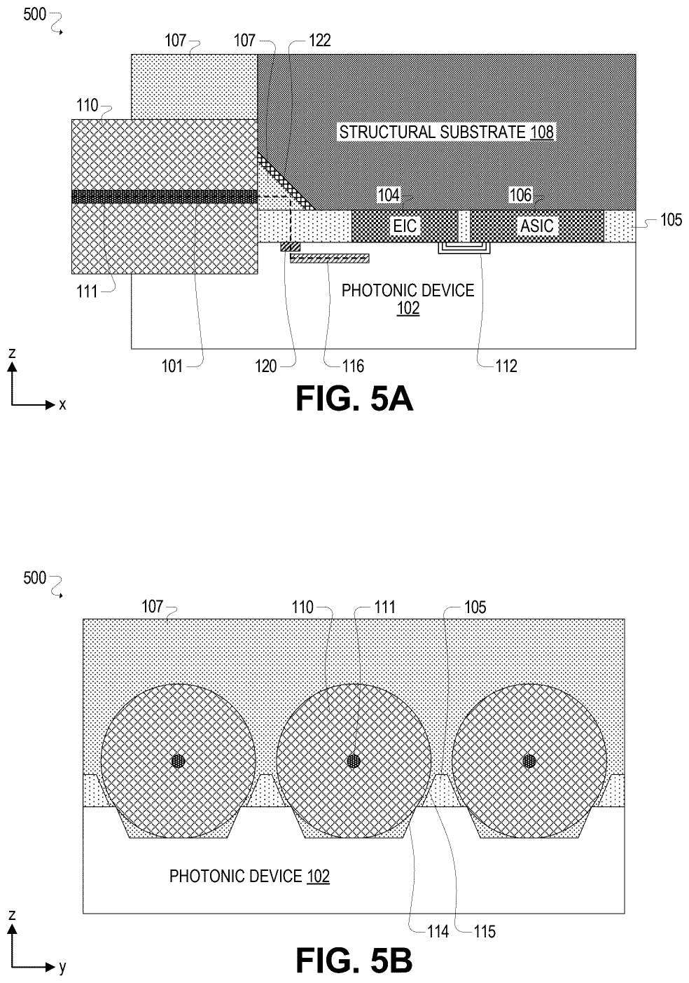

FIGS. 5A-B illustrate cross-section views of a microelectronic assembly 500 that uses vertical couplers 120 and a structural substrate 108 with embedded mirrors 122 for shifted out-of-plane light propagation. In particular, FIG. 5A shows a cross-section view taken from the x-z plane, and FIG. 5B shows a cross-section view taken from the y-z plane. In the illustrated embodiment, microelectronic assembly 500 is similar to microelectronic assembly 100, except the mirrors 122 are embedded in the structural substrate lid 108 instead of being fabricated monolithically in the propagation layer 105.

In particular, the structural substrate 108 includes one or more embedded mirrors 122, along with an index-matched material 107 in the area below the mirrors 122 to enable light propagation between the mirrors 122 and other adjacent layers in microelectronic assembly 500. In some embodiments, for example, the index-matched material 107 may have the same or similar refractive index as the propagation layer 105.

Moreover, in some embodiments, the structural substrate 108 with embedded mirrors 122 may be fabricated in a separate process (e.g., using the process flow of FIGS. 10A-J) and may be integrated into microelectronic assembly 500 during assembly.

In the illustrated embodiment, light propagates along the following path 101 through microelectronic assembly 500: photonic waveguide 116 to vertical (e.g., grating) coupler 120 to integrated mirror 122 to fiber core 111 (and vice versa). For example, when a light beam is transmitted from the photonic device 102 to one of the fibers 110, the beam propagates horizontally through a waveguide 116 of the photonic device 102 to a vertical coupler 120. The vertical coupler 120 redirects the light beam by an angle of about 90 degrees, which changes the beam's direction of propagation from horizontal to vertical, causing the beam to be emitted vertically from the top surface or frontside of the photonic device 102. As a result, the light beam propagates vertically into the integrated mirror 122 in the structural substrate 108, which reflects the light beam at an angle of about 90 degrees, causing beam's direction of propagation to change from vertical back to horizontal. The light beam then propagates horizontally—out of plane and above the surface of the photonic device 102—into the core 111 of the corresponding fiber 110. When a light beam is transmitted in the reverse direction (e.g., from one of the fibers 110 to the photonic device 102), the path of light propagation 101 flows in the reverse order.

In this manner, a light beam propagating horizontally in one of the waveguides 116 of the photonic device 102 is shifted vertically, or out of plane of the photonic device 102, such that the beam propagates horizontally above the surface of the photonic device 102. Since the mirrors 122 are integrated in the structural substrate 108 instead of the propagation layer 105, however, the mirrors 122 are positioned higher in microelectronic assembly 500 than in microelectronic assemblies 100-400, which shifts up beam propagation even higher. As a result, the fibers 110 are similarly repositioned higher up to align the fiber cores 111 with the higher out-of-plane light beams, which enables the depth of the v-grooves 114, and the thickness of the photonic device 102, to be reduced even further compared to microelectronic assemblies 100-400.

In some embodiments, for example, the light propagation path 101 may be shifted above the surface of the photonic device 102 by about 30-40μm, which enables the depth of the v-grooves 114 and the thickness of the photonic device 102 to be reduced by roughly the same amount (e.g., 30-40μm). In some cases, this may result in very shallow v-grooves 114 (e.g., with a depth of about 15μm), which can make fiber alignment challenging.

As a result, microelectronic assembly 500 includes secondary fiber alignment features 115 (e.g., slopes, grooves, stops) to help with fiber alignment (as shown in FIG. 5B). In particular, the fill material in the propagation layer 105 is patterned with coarse alignment and/or stop features 115 to help align the inserted fibers 110, and the structural substrate 108 also serves as a secondary stop feature for the inserted fibers 110.

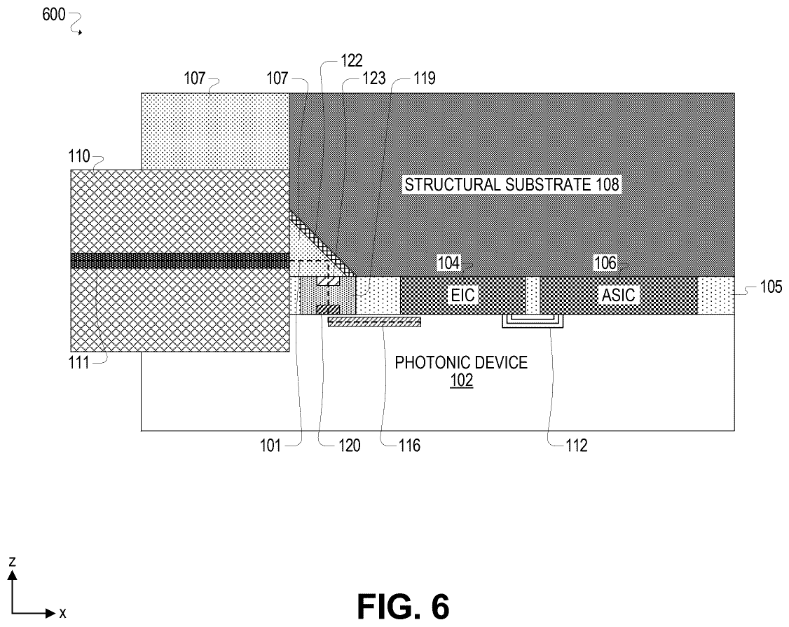

FIG. 6 illustrates a cross-section view of another microelectronic assembly 600 that uses vertical couplers 120 and a structural substrate 108 with embedded mirrors 122 for shifted out-of-plane light propagation. In the illustrated embodiment, microelectronic assembly 600 is similar to microelectronic assembly 500, except the vertical couplers 120 are implemented in an external passive device 119 (e.g., instead of in the photonic device 102), which also includes beam shapers 123 (e.g., spot size converters, microlens) to convert the mode size of light beams propagating between the waveguides 116 of the photonic device 102 and the cores 111 of the fibers 110.

In some embodiments, for example, an external passive device 119 with vertical couplers 120 and beam shapers 123 may be fabricated in a separate process (e.g., with a thickness of about 10-50μm) and then integrated into microelectronic assembly 600 (e.g., similar to the external passive devices 119 in microelectronic assemblies 200, 400). The beam shapers 123 may include any type of components for converting (e.g., expanding or contracting) the size of light beams (e.g., spot size, mode size, mode field diameter (MFD)), including, without limitation, spot size converters, lens for beam expansion/contraction (e.g., microlens, microlens array), mode field adapters, etc.

In the illustrated embodiment, light propagates along the following path 101 through microelectronic assembly 600: photonic waveguide 116 to vertical (e.g., grating) coupler 120 to beam shaper 123 to integrated mirror 122 to fiber core 111 (and vice versa). For example, when a light beam is transmitted from the photonic device 102 to one of the fibers 110, the beam propagates horizontally through a waveguide 116 of the photonic device 102 towards an integrated vertical coupler 120 in the external passive device 119. The integrated vertical coupler 120 redirects the light beam by an angle of about 90 degrees, which changes the beam's direction of propagation from horizontal to vertical, causing the beam to emit vertically from the top surface or frontside of the photonic device 102. The light beam then propagates vertically through the integrated beam shaper 123, which expands the mode size of the beam (or contracts the mode size when the beam propagates in the opposite direction). The expanded beam continues propagating vertically into the integrated mirror 122 of the structural substrate 108, which reflects the expanded beam at an angle of about 90 degrees, causing the beam's direction of propagation to change from vertical back to horizontal. The light beam then propagates horizontally—out of plane and above the surface of the photonic device 102—into the core 111 of the corresponding fiber 110. When a light beam is transmitted in the reverse direction (e.g., from one of the fibers 110 to the photonic device 102), the path of light propagation 101 flows in the reverse order.

Similar to microelectronic assembly 500, microelectronic assembly 600 shifts light propagation out of plane above the surface of the photonic device 102, which enables shallower v-grooves 114 and a thinner photonic device 102. Thus, in some embodiments, microelectronic assembly 600 may also include the secondary alignment features 115 of microelectronic assembly 500 to help with fiber alignment due to the shallower v-grooves 114 (e.g., as shown in FIG. 5B).

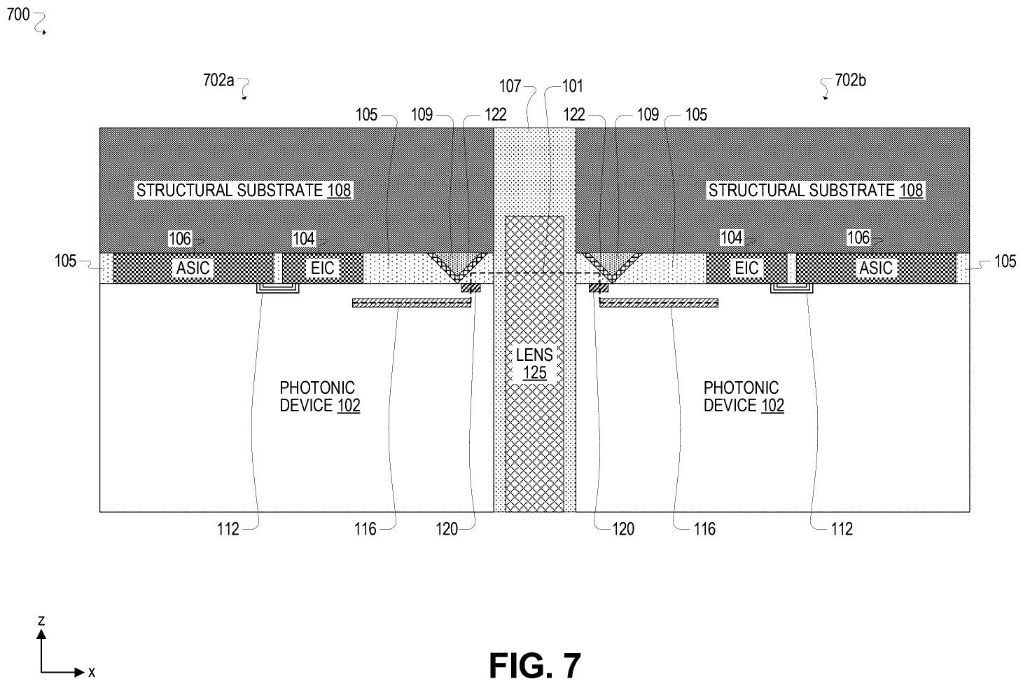

FIG. 7 illustrates an example of a microelectronic assembly 700 with shifted out-of-plane light propagation between multiple semiconductor chips 702a,b. In the illustrated embodiment, each chip 702a,b is similar to microelectronic assembly 100, except the chips 702a,b are optically coupled directly to each other through a lens 125 instead of being optically coupled to one or more optical fibers 110 (e.g., chip-to-chip instead of chip-to-fiber). In particular, microelectronic assembly 700 includes two chips 702a,b with a lens 125 between them, and the remaining area between the chips 702a,b is filled with an index-matched material 107 to enable light propagation between the chips 702a,b.

In the illustrated embodiment, light propagates along the following path 101 through microelectronic assembly 700: photonic waveguide 116 to vertical (e.g., grating) coupler 120 to mirror 122 in the first chip 702a, then to lens 125, then to mirror 122 to vertical (e.g., grating) coupler 120 to photonic waveguide 116 in the second chip 702b (and vice versa).

For example, when a light beam is transmitted from the first chip 702a to the second chip 702b, the photonic device 102 of the first chip 702a generates a light beam, which propagates horizontally through a photonic waveguide 116 to a vertical coupler 120. The vertical coupler 120 redirects the light beam by an angle of about 90 degrees, which changes the beam's direction of propagation from horizontal to vertical, causing the beam to be emitted vertically from the top surface or frontside of the photonic device 102. The light beam continues propagating vertically into the mirror 122, which reflects the beam at an angle of about 90 degrees, causing the beam's direction of propagation to change from vertical back to horizontal. The light beam then propagates horizontally—out of plane and above the surface of the photonic device 102—and is emitted from the edge of the first chip 702a.

The light beam continues propagating horizontally through the lens 125 between the respective chips 702a,b, which may be designed to perform any type or combination of optical functions to facilitate light propagation between the chips 702a,b, such as beam expansion/contraction, beam focusing/refocusing, beam collimation, etc. In some embodiments, for example, the lens 125 may include a microlens or microlens array for beam expansion and contraction, beam focusing/refocusing, and/or beam collimation. Alternatively, in some embodiments, the lens 125 may be replaced with any other type or combination of passive optical waveguide components to facilitate light propagation between the respective chips 702a,b.

The light beam then continues propagating horizontally into the second chip 702b until reaching the mirror 122, which reflects the beam at an angle of about 90 degrees, causing the beam's direction of propagation to change from horizontal back to vertical. The light beam continues propagating vertically into the vertical coupler 120, which redirects the light beam by an angle of about 90 degrees, causing the beam's direction of propagation to change from vertical back to horizontal. The light beam then propagates horizontally though the photonic waveguide 116 of the photonic device 102, where the beam is then processed by the photonic device 102 of the second chip 702b.

When a light beam is transmitted in the reverse direction (e.g., from the second chip 702b to the first chip 702a), the path of light propagation 101 flows in the reverse order.

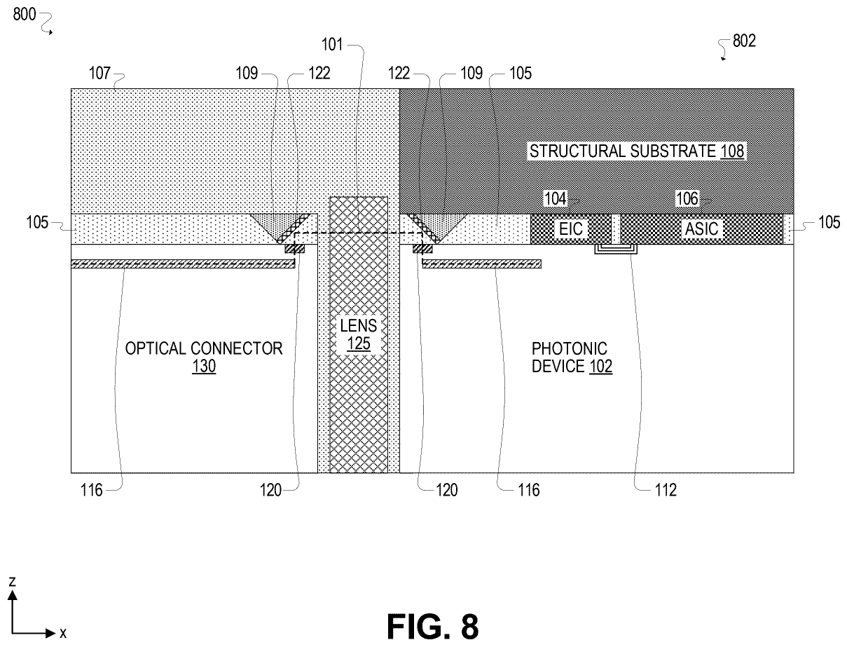

FIG. 8 illustrates an example of a microelectronic assembly 800 with shifted out-of-plane light propagation between a semiconductor chip 802 and an optical connector 130 via a one-dimensional (1D) waveguide array. In the illustrated embodiment, microelectronic assembly 800 is similar to microelectronic assembly 700, except a single chip 802 is optically coupled to an optical connector 130 instead of being optically coupled directly to another chip (e.g., chip-to-connector instead of chip-to-chip). In particular, microelectronic assembly 800 includes a chip 802 and an optical connector 130, along with a lens 125 between them, and the remaining area is filled with an index-matched material 107 to enable light propagation between the chip 802 and the connector 130. Chip 802 is similar to chip 702a,b in microelectronic assembly 700. Moreover, chip 802 and optical connector 130 each include a 1D array of photonic waveguides 116, along with corresponding vertical (e.g., grating) couplers 120 and mirrors 122 (e.g., where the mirrors 122 are in a propagation layer 105 above the surface of the photonic device 102 in the chip 802 and the optical connector 130, respectively). The waveguides 116, couplers 120, and mirrors 122 in the chip 802 and the optical connector 130, respectively, are arranged along the y axis, such that only one waveguide 116, coupler 120, and mirror 122 are visible from the illustrated x-z plane view.

In the illustrated embodiment, light propagates along the following path 101 through microelectronic assembly 800: photonic waveguide 116 to vertical (e.g., grating) coupler 120 to mirror 122 in the chip 802, then to lens 125, then to mirror 122 to vertical (e.g., grating) coupler 120 to photonic waveguide 116 in the optical connector 130 (and vice versa).

For example, when a light beam is transmitted from the chip 802 to the optical connector 130, the photonic device 102 in the chip 802 generates a light beam, which propagates horizontally through a photonic waveguide 116 to a vertical coupler 120. The vertical coupler 120 redirects the light beam by an angle of about 90 degrees, which changes the beam's direction of propagation from horizontal to vertical, causing the beam to be emitted vertically from the top surface or frontside of the photonic device 102. The light beam continues propagating vertically into the mirror 122, which reflects the beam at an angle of about 90 degrees, causing the beam's direction of propagation to change from vertical back to horizontal. The light beam then propagates horizontally—out of plane and above the surface of the photonic device 102—and is emitted from the edge of the chip 802.

The light beam continues propagating horizontally through the lens 125 between the chip 802 and the connector 130, which may be designed to perform any type or combination of optical functions to facilitate light propagation between the chip 802 and the connector 130, such as beam expansion/contraction, beam focusing/refocusing, beam collimation, etc. (e.g., similar to the lens 125 in microelectronic assembly 700). Alternatively, in some embodiments, the lens 125 may be replaced with any other type or combination of passive optical waveguide components to facilitate light propagation between the chip 802 and the connector 130.

The light beam then continues propagating horizontally into the optical connector 130 until reaching the mirror 122, which reflects the beam at an angle of about 90 degrees, causing the beam's direction of propagation to change from horizontal back to vertical. The light beam continues propagating vertically into the vertical coupler 120, which redirects the light beam by an angle of about 90 degrees, causing the beam's direction of propagation to change from vertical back to horizontal. The light beam then propagates horizontally though a photonic waveguide 116 in the optical connector 130, where the beam eventually reaches another component (not shown) connected to the other side of the optical connector 130.

In some embodiments, for example, the optical connector 130 is designed to removably connect to another component, such as a fiber array unit (FAU). In particular, the FAU may include an array of optical (e.g., glass) fibers with ferrules attached to the respective ends of the fiber array, where one of the ferrules is designed to interface with the optical connector 130 and the other is designed to interface with another component (e.g., a ferrule on another fiber cable, a socket on a photonic device, etc.). In this manner, one end of the FAU can be removably connected, or plugged into, the optical connector 130 and the other end can be connected to the other component, thus optically coupling the chip 802 to the other component.

When a light beam is transmitted in the reverse direction (e.g., from another component through the optical connector 130 and to the chip 802), the path of light propagation 101 flows in the reverse order.

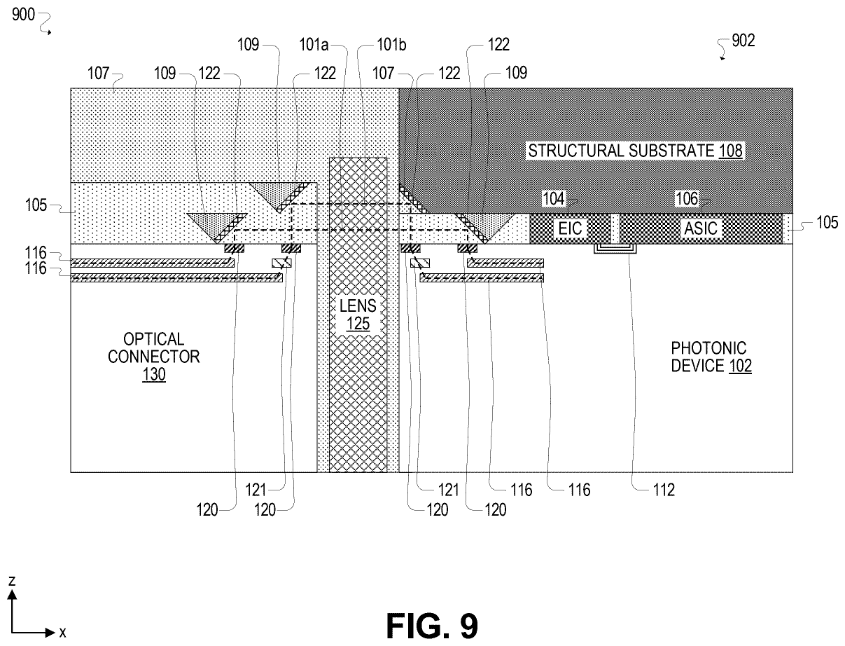

FIG. 9 illustrates an example of a microelectronic assembly 900 with shifted out-of-plane light propagation between a semiconductor chip 902 and an optical connector 130 via a two-dimensional (2D) waveguide array. In the illustrated embodiment, microelectronic assembly 900 is similar to microelectronic assembly 800, except the chip 902 and the optical connector 130 each include a 2D array of photonic waveguides 116 (e.g., instead of a 1D array), along with corresponding vertical (e.g., grating) couplers 120, lateral (e.g., evanescent) couplers 121, and mirrors 122. The waveguides 116, couplers 120, 121, and mirrors 122 in the chip 902 and the optical connector 130, respectively, are arranged along the z and y axes in a 2×N array, such that only two waveguides 116 (and associated couplers 120, 121 and mirrors 122) are visible in the illustrated x-z plane view. Thus, in the illustrated example, two paths of light propagation 101a,b are shown between the chip 902 and the optical connector 130. Moreover, microelectronic assembly 900 includes two layers of mirrors 122 for the respective light propagation paths 101a,b, where one of the mirrors 122 is embedded in the structural substrate 108 of the chip 902, and the other mirrors 122 are embedded in the respective propagation layers 105 above the photonic device 102 and the optical connector 130.

With respect to the first light propagation path 101a, when a light beam is transmitted from the chip 902 to the optical connector 130, the beam propagates through microelectronic assembly 900 as follows: from photonic device 102 in chip 902 to photonic waveguide 116 to vertical (e.g., grating) coupler 120 to lower mirror 122 in propagation layer 105, then through lens 125, then to optical connector 130 to lower mirror 122 in propagation layer 105 to vertical (e.g., grating) coupler 120 to photonic waveguide 116.

With respect to the second light propagation path 101b, when a light beam is transmitted from the chip 902 to the optical connector 130, the beam propagates through microelectronic assembly 900 as follows: from photonic device 102 in chip 902 to photonic waveguide 116 to lateral (e.g., evanescent) coupler 121 to vertical (e.g., grating) coupler 120 to upper mirror 122 in structural substrate 108, then through lens 125, then to optical connector 130 to upper mirror 122 in propagation layer 105 to vertical (e.g., grating) coupler 120 to lateral (e.g., evanescent) coupler 121 to photonic waveguide 116.

When a light beam is transmitted in the reverse direction along either path 101a,b (e.g., from another component through the optical connector 130 and to the chip 802), the path of light propagation 101a,b flows in the reverse order.

Moreover, in other embodiments, microelectronic assembly 900 can be scaled to support out-of-plane light propagation over a 2D waveguide array of any size or dimensions.

FIGS. 10A-J illustrate an example process flow for forming substrates 1000 with embedded mirrors 1004. In some embodiments, for example, the illustrated process flow may be used to form structural substrates with embedded mirrors (e.g., structural substrate 108 with embedded mirrors 122 of microelectronic assemblies 500, 600, 900) or passive optical devices with embedded mirrors (e.g., passive optical device 119 of microelectronic assembly 200). In the illustrated example, FIGS. 10A-J show cross-section views (x-z plane) after performing various steps of the process flow. It will be appreciated in light of the present disclosure that the illustrated process flow is only one example methodology for arriving at structural substrates 1000 with mirrors 1004.

In FIG. 10A, a substrate 1000 is received. In some embodiments, the substrate 1000 may include silicon (e.g., a silicon wafer or panel).

In FIG. 10B, a layer of photoresist 1002 is formed over the substrate 1000, which is patterned (e.g., using photolithography) with openings over areas 1001 of the substrate 1000 where the mirrors will be formed.

In FIG. 10C, the substrate 1000 is etched in the areas 1001 that are not covered by photoresist 1002 (e.g., using anisotropic etching), thus removing portions of the substrate 1000 in the areas 1001 where the mirrors will be formed.

In FIG. 10D, a layer of reflective material 1004 for the mirrors is formed over the substrate 1004. The reflective material 1004 may include any material capable of reflecting light of the appropriate wavelengths for the particular application (e.g., any of the reflective/mirror materials disclosed herein).

In FIG. 10E, an index-matching material 1006 is deposited over the reflective material 1004, and the surface of the substrate 1002 is planarized. In this manner, the reflective material 1004 and the index-matching material 1006 only remain in the areas 1001 of the substrate 1000 that were etched away for the mirrors.

The index-matching material 1006 may be a material with the same or similar refractive index as other adjacent materials in the subsequently assembled semiconductor chips, which reduces reflections and losses at the interfaces between those materials and enables light to propagate between them efficiently. In some embodiments, for example, the index-matching material 1006 may have the same or similar refractive index as layer 105 in the microelectronic assemblies disclosed herein.

In FIG. 10F, another layer of photoresist 1008 is formed over the substrate 1000, which is patterned (e.g., using photolithography) with openings over areas 1003 of the substrate 1000 that will be diced.

In FIG. 10G, the substrate 1000 is partially diced (e.g., without dicing all the way through its full thickness) in areas 1003 that are not covered by photoresist 1008 (e.g., using dry etching and plasma dicing).

In FIG. 10H, the substrate 1000 is placed face down on a carrier substrate 1010 (e.g., using pick and place assembly).

In FIG. 10I, the substrate 1000 is bonded to the carrier substrate 1010, and the backside of the substrate 1000 is thinned to the partially diced/etched areas 1003 (e.g., by grinding the backside of the substrate 1000). In this manner, the substrate 1000 is fully diced into multiple smaller substrate units 1000a-d.

In FIG. 10J, the carrier substrate 1010 is debonded, separated, and/or removed from the diced substrates 1000a-d, thus fully singulating the respective substrates 1000a-d. The resulting substrates 1000a-d each include a mirror 1004 along with an index-matching material 1006 over the mirror 1004.

At this point, the processing may be complete, and the substrates 1000a-d may subsequently be incorporated into semiconductor chips or assemblies. In some embodiments, for example, the substrates 1000a-d may be used as structural substrates with embedded mirrors (e.g., structural substrate 108 with embedded mirrors 122 of microelectronic assemblies 500, 600, 900) or passive optical devices with embedded mirrors (e.g., passive optical device 119 of microelectronic assembly 200).

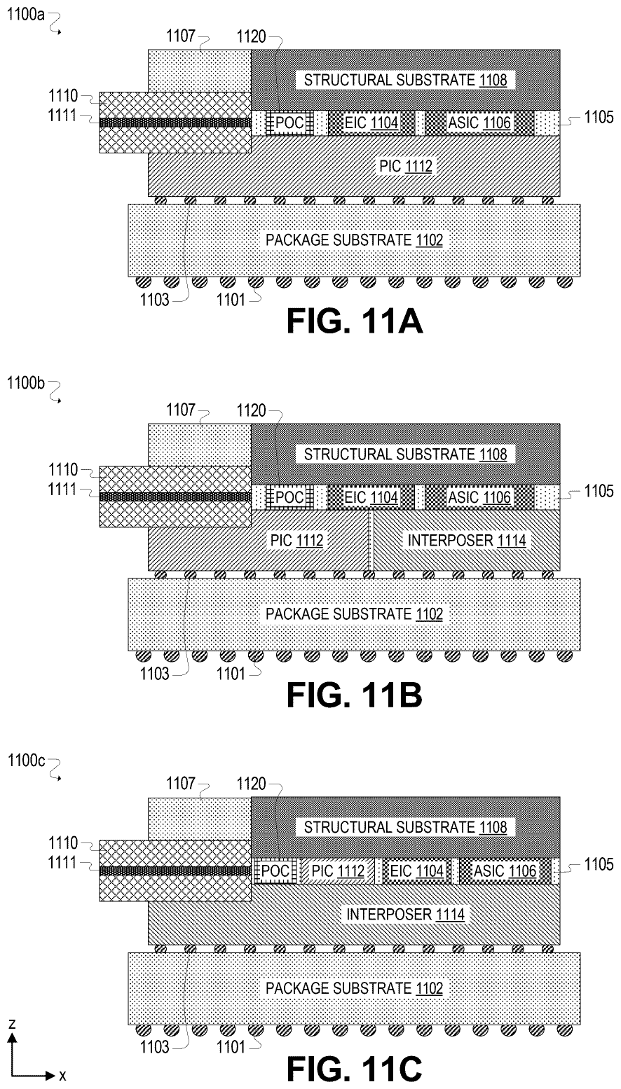

FIGS. 11A-C illustrate cross-section views of various example configurations of microelectronic assemblies 1100a-c with out-of-plane light propagation. Any of the embodiments disclosed herein may be implemented using the configurations shown for microelectronic assemblies 1100a-c.

In FIG. 11A, microelectronic assembly 1100a includes a structural substrate 1108, which is attached on top of an application-specific integrated circuit (ASIC) 1106, an electronic integrated circuit (EIC) 1104, and one or more passive optical components (POCs) 1120. The ASIC 1106, EIC 1104, and POCs 1120 are attached on top of a photonic integrated circuit (PIC) 1112, which in turn is attached on top of a package substrate 1102. Moreover, one or more optical (e.g., glass) fibers 1110 are attached to the edge of the PIC 1112 (e.g., within grooves on the PIC 1112 surface).

The passive optical components 1120 are used to shift or redirect light propagation out-of-plane from the PIC 1112 to the layer 1105 above and then into the core 1111 of the fibers 1110. In this manner, the fibers 1110 are also shifted up, which enables the grooves on the PIC 1112 to be shallower. The passive optical components 1120 may include any suitable components for guiding or directing light, including, without limitation, vertical couplers 120 (e.g., grating couplers), lateral couplers 121 (e.g., evanescent couplers), mirrors 122, waveguides, and beam shapers 123 (e.g., spot size converters 124, lens 125, beam expanders, mode converters, mode field adapters). The light propagation layer 1105, along with adjacent layers 1107 through which light may propagate, may be filled with index-matching materials that are transparent to light.

In the illustrated embodiment, the ASIC 1106 and the EIC 1104 are electrically coupled to the PIC 1112 via a hybrid bond interconnect (HBI). In hybrid bond interconnects, also known as direct bond interconnects (DBI), bonding pads on two opposing semiconductor dies and/or substrates are interconnected such that respective metal (e.g., copper) bonding pads on the dies/substrates are directly bonded together through metal-to-metal bonds (e.g., without intervening conductive materials such as solder compounds between the bonding pads). Similarly, dielectric materials adjacent the respective metal pads are also bonded directly together through dielectric-to-dielectric bonds (e.g., without intervening dielectric materials such as adhesives, molding compound, underfill material, and the like). In the illustrated embodiment, for example, the ASIC 1106 and the EIC 1104 are hybrid bonded face down on the PIC 1112, such that the frontside of the ASIC 1106 and the EIC 1104 is bonded to the frontside of the PIC 1112. In this manner, a hybrid dielectric-to-dielectric and metal-to-metal bond is formed between the ASIC 1106 and EIC 1104 and the PIC 1112, such that a dielectric layer on the face of the ASIC 1106 and the EIC 1104 is bonded to a dielectric layer on the face of the PIC 1112 and pads on the ASIC 1106 and EIC 1104 are bonded to pads on the PIC 1112.

In the illustrated embodiment, the PIC 1112 includes photonic circuitry for optical communication, along with optical and electrical routing (not shown) (e.g., optical waveguides, conductive traces, vias, embedded interconnect bridges). The ASIC 1106 and the EIC 1104 may be electrically coupled to each other, and to the package substrate 1102, via the electrical routing in the PIC 1112. Moreover, one end of the fibers 1110 is optically coupled to the PIC 1112, and the other end of the fibers 1110 is optically coupled to another component (not shown). In this manner, the ASIC 1106 can use the EIC 1104 and the PIC 1112 to communicate optically via the fibers 1110.

The PIC 1112 is electrically coupled to the top side of the package substrate 1102 via conductive bumps 1103 (e.g., a ball grid array (BGA) or micro-BGA interconnect). Moreover, the package substrate 1102 includes electrical routing (not shown) (e.g., conductive traces, vias, through-silicon vias (TSVs), through-glass vias (TGVs), embedded interconnect bridges) to provide power and input/output (I/O) to the respective components in microelectronic assembly 1100a (e.g., ASIC 1106, EIC 1104, PIC 1112). The package substrate 1102 also includes conductive bumps 1101 (e.g., a BGA interconnect) on the bottom side to interconnect with other components (not shown), such as a printed circuit board (e.g., motherboard) and/or another microelectronic assembly.

In FIG. 11B, microelectronic assembly 1100b is similar to microelectronic assembly 1100a of FIG. 11A, except an electrical interposer 1114 is added next to the PIC 1112 to provide the electrical routing for the EIC 1104 and the ASIC 1106. In particular, the electrical interposer 1114 is attached to the package substrate 1102 next to the PIC 1112, the EIC 1104 is electrically coupled (e.g., hybrid bonded) to both the PIC 1112 and the interposer 1114, and the ASIC 1106 is electrically coupled (e.g., hybrid bonded) only to the interposer 1114. The interposer 1114 includes electrical routing (e.g., conductive pads, traces, vias, through-silicon vias (TSVs), embedded interconnect bridges) to interconnect the EIC 1104 and the ASIC 1106 to each other and/or to the package substrate 1102. In this manner, the EIC 1104 is directly connected to the PIC 1112 and the interposer 1114, and the EIC 1104 is indirectly connected to the ASIC 1106 and the package substrate 1102 through the interposer 1114. Moreover, the ASIC 1106 is directly connected to the interposer 1114, and the ASIC 1106 is indirectly connected to the EIC 1104 and the package substrate 1102 through the interposer 1114.

In FIG. 11C, microelectronic assembly 1100c is similar to microelectronic assembly 1100a of FIG. 11A, except an optical/electrical interposer 1114 is attached directly to the package substrate 1102 (e.g., instead of the PIC 1112), the PIC 1112 is repositioned on top of the interposer 1114, and the ASIC 1106, EIC 1104, POCs 1120, and fibers 1110 are attached to the interposer 1114 instead of the PIC 1112. In this manner, the ASIC 1106, EIC 1104, PIC 1112, and POCs 1120 are on top of the interposer 1114, and the fibers 1110 are on the edge of the interposer 1114 (e.g., within v-grooves). Moreover, the interposer 1114 includes optical and electrical routing (not shown), such as optical waveguides and/or other passive optical components, conductive pads, traces, vias, through-glass vias (TGVs), through-silicon vias (TSVs), embedded interconnect bridges, and so forth. In particular, the interposer 1114 includes optical routing to optically couple the PIC 1112 to the fibers 1110, and the interposer 1114 includes electrical routing to electrically couple the EIC 1104 and the ASIC 1106 to each other and/or to the package substrate 1102.

It should be appreciated that microelectronic assemblies 1100a-c are merely presented as examples. In other embodiments, certain components may be omitted, added, replaced, rearranged, modified, and/or combined. For simplicity, only some instances of the elements shown in microelectronic assemblies 1100a-c are labeled with reference numerals. Further, some components of microelectronic assemblies 1100a-c may be similar to those of microelectronic assemblies 100, 200, 300, 400, 500, 600, 700, 800, and 900 of FIGS. 1-9, and any of the variations described above with respect to those embodiments also apply to microelectronic assemblies 1100a-c, and vice versa. For example, while microelectronic assemblies 1100a-c implement chip-to-fiber optical coupling, other embodiments of microelectronic assemblies 1100a-c may implement chip-to-chip optical coupling (e.g., microelectronic assembly 700 of FIG. 7) or chip-to-connector optical coupling (e.g., microelectronic assemblies 800, 900 of FIGS. 8, 9).

Moreover, in some embodiments, the package substrate 1102 may be omitted, and the PIC 1112 or interposer 1114 may serve as the package substrate. Further, while some components are described above as being bonded to other components on the frontside or backside, those components can also be bonded on the reverse sides depending on the implementation of the components (e.g., for backside power delivery architectures, gate-all-around transistors, etc.).

The PIC 1112 may include any suitable photonic components and circuitry for sending and receiving optical signals (e.g., over the fibers 1110), such as laser diodes (LD), modulators (LD-MOD) (e.g., for transmitting optical signals), optical filters, amplifiers, photodiodes (PD) (e.g., for receiving optical signals), waveguides, optical couplers, collimation/refocusing lenses, reflection mirrors, beam shaping devices, and so forth.

The EIC 1104 may include any suitable electronic components and circuitry for controlling the PIC 1112, such as drivers, transimpedance amplifiers (TIA), carrier phase recovery (CPR) circuitry, clock/data recovery (CDR) circuitry, serializers/deserializers, equalizers, samplers, electrostatic discharge (ESD) circuits, digital processing circuits, memory circuits, and so forth. Moreover, while the EIC 1104 is used to control the PIC 1112 in the illustrated embodiment, the EIC 1104 may be any type of electronic integrated circuit in other embodiments (e.g., ASIC, XPU, processor, memory, etc.).

The fibers 1110 may include any type, number, and/or arrangement of optical waveguides, including, but not limited to, glass fibers. The other end of the fibers 1110 may be optically coupled to other components (not shown), which enables the PIC 1112 to send and receive optical signals to and from those components, such as other computing components that are part of the same device or system microelectronic assemblies 1100a-c (e.g., processors, XPUs, network interface controllers (NICs), storage, memory, I/O devices, other integrated circuits), an external device or system, a switch, an optical connector, a fiber cable, and so forth.

The ASIC 1106 may include any type or combination of integrated circuitry that may use the EIC 1104 and/or the PIC 1112 for optical communication. For example, the ASIC 1106 may include any type or combination of processing units or other computing components, including, but not limited to, microcontrollers, microprocessors, processor cores, central processing units (CPUs), graphics processing units (GPUs), vision processing units (VPUs), tensor processing units (TPUs), application-specific integrated circuits (ASICs), field-programmable gate arrays (FPGAs), input/output (I/O) controllers and devices, switches, network interface controllers (NICs), persistent storage devices, and memory.

In some embodiments, microelectronic assembly 1100a-c may be part of an electronic device or system, such as a mobile device, a wearable device, a computer, a server, a video playback device, a video game console, a display device, a camera, or an appliance. For example, microelectronic assembly 1100a-c and various other electronic components may be electrically coupled to a circuit board within the electronic device.

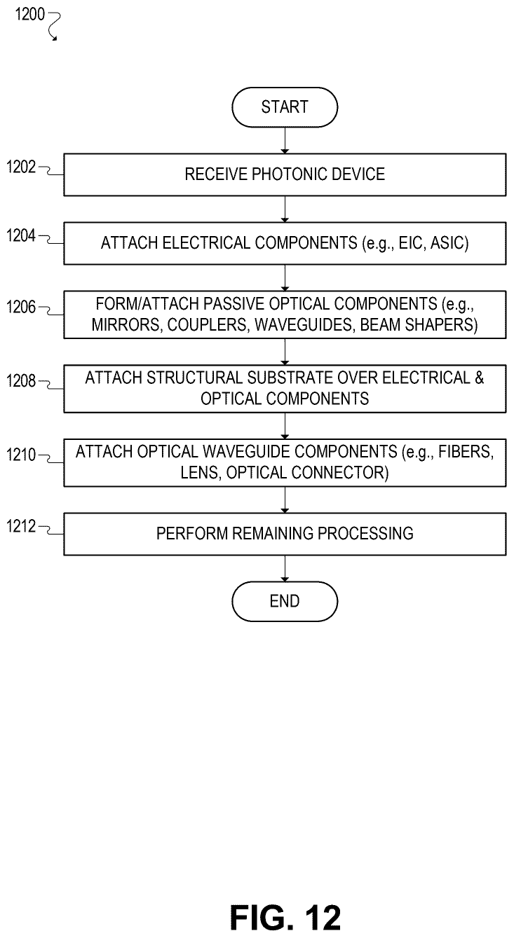

FIG. 12 illustrates a process flow 1200 for forming microelectronic assemblies with out-of-plane light propagation in accordance with certain embodiments. In some embodiments, for example, the illustrated process flow may be used to form microelectronic assemblies 100, 200, 300, 400, 500, 600, 700, 800, 900, and 1100a-c. However, it will be appreciated in light of this disclosure that the illustrated process flow is only one example methodology for arriving at the example embodiments shown and described throughout this disclosure.

The process flow begins at block 1202 by receiving a photonic device. In some embodiments, the photonic device may be a photonic die, such as a photonic integrated circuit (PIC) and/or an optical interposer.

The process flow then proceeds to block 1204 to attach one or more electrical components (e.g., EIC, ASIC) to the photonic device. In some embodiments, for example, an EIC and/or an ASIC may be hybrid bonded to the frontside of the photonic device.

The process flow then proceeds to block 1206 to form and/or attach one or more passive optical components over the frontside of the photonic device, such as optical couplers (e.g., vertical couplers, lateral couplers), mirrors, beam shapers (e.g., spot size converters, lens, beam expanders, mode converters, mode field adapters), waveguides, and so forth.

In some embodiments, for example, some or all of the passive optical components may be fabricated monolithically (e.g., in situ) over the photonic device. Alternatively, or additionally, some or all of the passive optical components may be fabricated separately as external devices and then integrated or assembled over the photonic device. Moreover, the surrounding areas may be filled with an index-matching material that is transparent to light (e.g., an epoxy).

The process flow then proceeds to block 1208 to attach a structural substrate over the optical and electrical components. In some embodiments, the structural substrate may be made of a material that includes silicon (e.g., a silicon substrate, wafer, or panel). Moreover, in some embodiments, the structural substrate may include one or more passive optical components (e.g., mirrors, optical couplers, beam shapers, waveguides).

The process flow then proceeds to block 1210 to attach one or more external optical waveguide components to the photonic device, such as optical fibers, a fiber array unit (FAU), a lens, an optical connector, etc.

The process flow then proceeds to block 1212 to perform any remaining processing, such as inter-layer dielectric (ILD) filling and planarization, attaching the completed chip to a package substrate, attaching another chip, singulation, etc. In wafer-level or panel-level process flows, for example, the resulting panel or wafer may be diced to singulate the individual units of microelectronic assemblies or semiconductor chips on the wafer or panel. The singulated chips may then be attached to, or assembled in, another IC package, a printed circuit board (PCB), and/or an electronic device or system (e.g., IC device 1400, electronic device 1500), among other examples. In some embodiments, for example, the backside of the photonic device may be attached, and electrically coupled to, a package substrate via the interconnect bumps on the backside of the interposer, and in turn, the package substrate may be electrically coupled to a PCB.

At this point, the process flow may be complete. In some embodiments, however, the process flow may restart and/or certain blocks may be repeated. For example, in some embodiments, the process flow may restart at block 1202 to continue forming microelectronic assemblies with out-of-plane light propagation.

### Example Integrated Circuit Embodiments

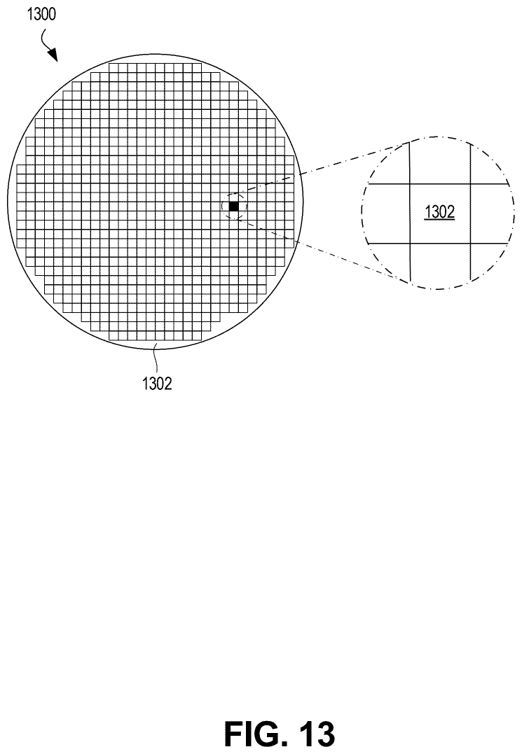

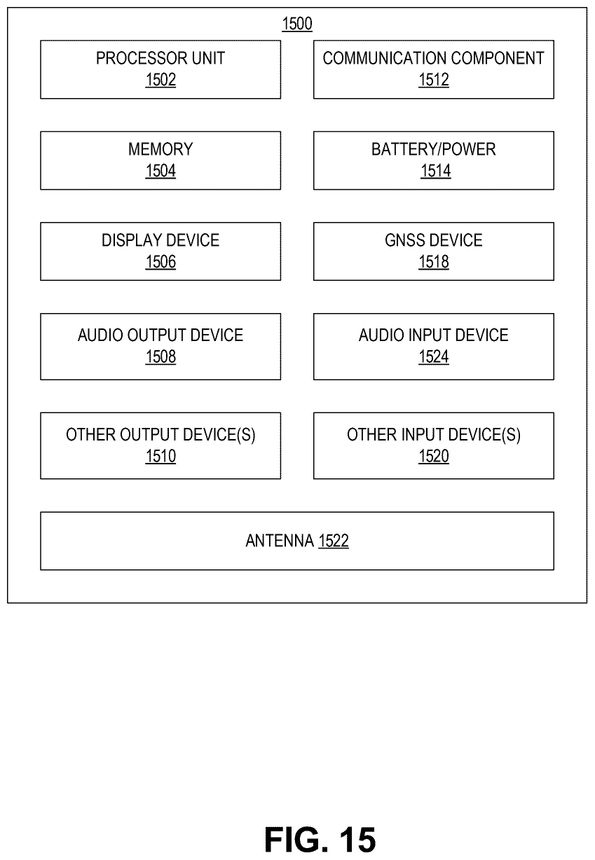

FIG. 13 illustrates a top view of a wafer 1300 and dies 1302 that may be included in any of the embodiments disclosed herein. The wafer 1300 may be composed of semiconductor material and may include one or more dies 1302 having integrated circuit structures formed on a surface of the wafer 1300. The individual dies 1302 may be a repeating unit of any integrated circuit component, device, assembly, or product (e.g., photonic devices 102, PICs 1112, interposers 1114, EICs 104, 1104, ASICs 106, 1106, structural substrates 108, 1000, 1108, passive optical devices 119, passive optical components 120-125, 1120, optical connectors 130, package substrates 1102, microelectronic assemblies 100, 200, 300, 400, 500, 600, 700, 800, 900, 1100a-c). After the fabrication of the semiconductor product is complete, the wafer 1300 may undergo a singulation process in which the dies 1302 are separated from one another to provide discrete “chips” of the integrated circuit product. The die 1302 may be any of the dies disclosed herein. The die 1302 may include one or more transistors, supporting circuitry to route electrical signals to the transistors, passive components (e.g., signal traces, resistors, capacitors, or inductors), and/or any other integrated circuit components. In some embodiments, the wafer 1300 or the die 1302 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1302. For example, a memory array formed by multiple memory devices may be formed on a same die 1302 as a processor unit (e.g., the processor unit 1502 of FIG. 15) or other logic that is configured to store information in the memory devices or execute instructions stored in the memory array. Various ones of the microelectronic assemblies disclosed herein may be manufactured using a die-to-wafer assembly technique in which some dies are attached to a wafer 1300 that include others of the dies, and the wafer 1300 is subsequently singulated.

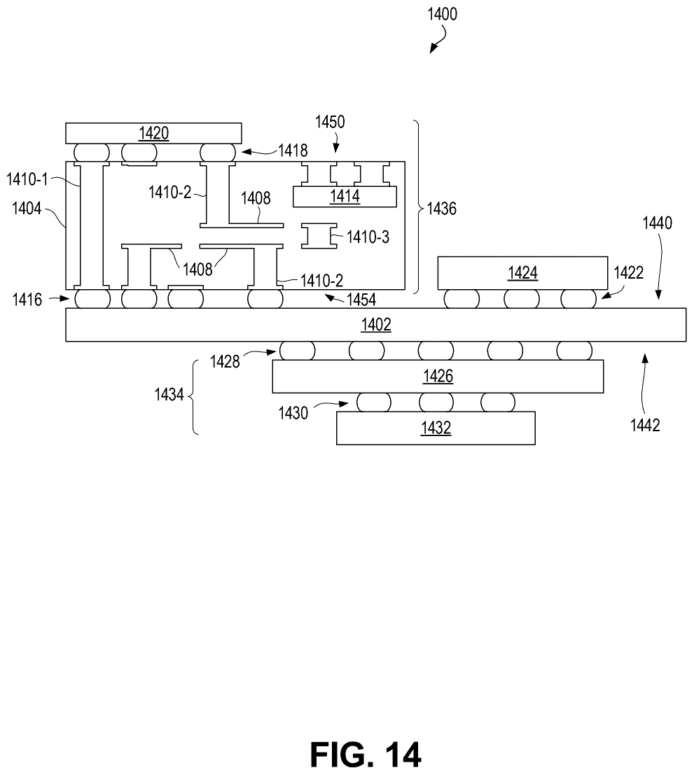

FIG. 14 illustrates a cross-sectional side view of an integrated circuit device assembly 1400 that may include any of the embodiments disclosed herein (e.g., photonic devices 102, PICs 1112, interposers 1114, EICs 104, 1104, ASICs 106, 1106, structural substrates 108, 1000, 1108, passive optical devices 119, passive optical components 120-125, 1120, optical connectors 130, package substrates 1102, microelectronic assemblies 100, 200, 300, 400, 500, 600, 700, 800, 900, 1100a-c).

In some embodiments, the integrated circuit device assembly 1400 may be a microelectronic assembly. The integrated circuit device assembly 1400 includes a number of components disposed on a circuit board 1402 (which may be a motherboard, system board, mainboard, etc.). The integrated circuit device assembly 1400 includes components disposed on a first face 1440 of the circuit board 1402 and an opposing second face 1442 of the circuit board 1402; generally, components may be disposed on one or both faces 1440 and 1442. Any of the integrated circuit components discussed below with reference to the integrated circuit device assembly 1400 may take the form of any suitable ones of the embodiments of the microelectronic assemblies disclosed herein.

In some embodiments, the circuit board 1402 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1402. In other embodiments, the circuit board 1402 may be a non-PCB substrate. The integrated circuit device assembly 1400 illustrated in FIG. 14 includes a package-on-interposer structure 1436 coupled to the first face 1440 of the circuit board 1402 by coupling components 1416. The coupling components 1416 may electrically and mechanically couple the package-on-interposer structure 1436 to the circuit board 1402, and may include solder balls (as shown in FIG. 14), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1416 may serve as the coupling components illustrated or described for any of the substrate assembly or substrate assembly components described herein, as appropriate.

The package-on-interposer structure 1436 may include an integrated circuit component 1420 coupled to an interposer 1404 by coupling components 1418. The coupling components 1418 may take any suitable form for the application, such as the forms discussed above with reference to the coupling components 1416. Although a single integrated circuit component 1420 is shown in FIG. 14, multiple integrated circuit components may be coupled to the interposer 1404; indeed, additional interposers may be coupled to the interposer 1404. The interposer 1404 may provide an intervening substrate used to bridge the circuit board 1402 and the integrated circuit component 1420.

The integrated circuit component 1420 may be a packaged or unpackaged integrated circuit product that includes one or more integrated circuit dies (e.g., die 1302 of FIG. 13) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1420, a single monolithic integrated circuit die comprises solder bumps attached to contacts on the die. The solder bumps allow the die to be directly attached to the interposer 1404. The integrated circuit component 1420 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1420 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1420 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1420 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1404 may spread connections to a wider pitch or reroute a connection to a different connection. For example, the interposer 1404 may couple the integrated circuit component 1420 to a set of ball grid array (BGA) conductive contacts of the coupling components 1416 for coupling to the circuit board 1402. In the embodiment illustrated in FIG. 14, the integrated circuit component 1420 and the circuit board 1402 are attached to opposing sides of the interposer 1404; in other embodiments, the integrated circuit component 1420 and the circuit board 1402 may be attached to a same side of the interposer 1404. In some embodiments, three or more components may be interconnected by way of the interposer 1404.

In some embodiments, the interposer 1404 may be formed as a PCB, including multiple metal layers separated from one another by layers of dielectric material and interconnected by electrically conductive vias. In some embodiments, the interposer 1404 may be formed of an epoxy resin, a fiberglass-reinforced epoxy resin, an epoxy resin with inorganic fillers, a ceramic material, or a polymer material such as polyimide. In some embodiments, the interposer 1404 may be formed of alternate rigid or flexible materials that may include the same materials described above for use in a semiconductor substrate, such as silicon, germanium, and other group III-V and group IV materials. The interposer 1404 may include metal interconnects 1408 and vias 1410, including but not limited to through hole vias 1410-1 (that extend from a first face 1450 of the interposer 1404 to a second face 1454 of the interposer 1404), blind vias 1410-2 (that extend from the first or second faces 1450 or 1454 of the interposer 1404 to an internal metal layer), and buried vias 1410-3 (that connect internal metal layers).

In some embodiments, the interposer 1404 can comprise a silicon interposer. Through silicon vias (TSV) extending through the silicon interposer can connect connections on a first face of a silicon interposer to an opposing second face of the silicon interposer. In some embodiments, an interposer 1404 comprising a silicon interposer can further comprise one or more routing layers to route connections on a first face of the interposer 1404 to an opposing second face of the interposer 1404.

The interposer 1404 may further include embedded devices 1414, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1404. The package-on-interposer structure 1436 may take the form of any of the package-on-interposer structures known in the art. In embodiments where the interposer is a non-printed circuit board

The integrated circuit device assembly 1400 may include an integrated circuit component 1424 coupled to the first face 1440 of the circuit board 1402 by coupling components 1422. The coupling components 1422 may take the form of any of the embodiments discussed above with reference to the coupling components 1416, and the integrated circuit component 1424 may take the form of any of the embodiments discussed above with reference to the integrated circuit component 1420.

The integrated circuit device assembly 1400 illustrated in FIG. 14 includes a package-on-package structure 1434 coupled to the second face 1442 of the circuit board 1402 by coupling components 1428. The package-on-package structure 1434 may include an integrated circuit component 1426 and an integrated circuit component 1432 coupled together by coupling components 1430 such that the integrated circuit component 1426 is disposed between the circuit board 1402 and the integrated circuit component 1432. The coupling components 1428 and 1430 may take the form of any of the embodiments of the coupling components 1416 discussed above, and the integrated circuit components 1426 and 1432 may take the form of any of the embodiments of the integrated circuit component 1420 discussed above. The package-on-package structure 1434 may be configured in accordance with any of the package-on-package structures known in the art.

FIG. 15 illustrates a block diagram of an example electronic device 1500 that may include one or more of the embodiments disclosed herein. For example, any suitable ones of the components of the electronic device 1500 may include one or more of the photonic devices 102, PICs 1112, interposers 1114, EICs 104, 1104, ASICs 106, 1106, structural substrates 108, 1000, 1108, passive optical devices 119, passive optical components 120-125, 1120, optical connectors 130, package substrates 1102, microelectronic assemblies 100, 200, 300, 400, 500, 600, 700, 800, 900, 1100a-c, integrated circuit device assemblies 1400, integrated circuit components 1420, or integrated circuit dies 1302 disclosed herein. In some embodiments, for example, the electronic device 1500 and/or its respective components (e.g., processor units 1502, input/output (I/O) devices 1510, 1520, communication components 1512, memory 1504) may include an optical interface for optical communication according to any of the embodiments described herein (e.g., with passive optical components for shifted out-of-plane light propagation).

A number of components are illustrated in FIG. 15 as included in the electronic device 1500, but any one or more of these components may be omitted or duplicated, as suitable for the application. In some embodiments, some or all of the components included in the electronic device 1500 may be attached to one or more motherboards mainboards, or system boards. In some embodiments, one or more of these components are fabricated onto a single system-on-a-chip (SoC) die.

Additionally, in various embodiments, the electronic device 1500 may not include one or more of the components illustrated in FIG. 15, but the electronic device 1500 may include interface circuitry for coupling to the one or more components. For example, the electronic device 1500 may not include a display device 1506, but may include display device interface circuitry (e.g., a connector and driver circuitry) to which a display device 1506 may be coupled. In another set of examples, the electronic device 1500 may not include an audio input device 1524 or an audio output device 1508, but may include audio input or output device interface circuitry (e.g., connectors and supporting circuitry) to which an audio input device 1524 or audio output device 1508 may be coupled.

The electronic device 1500 may include one or more processor units 1502 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1502 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electronic device 1500 may include a memory 1504, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1504 may include memory that is located on the same integrated circuit die as the processor unit 1502. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electronic device 1500 can comprise one or more processor units 1502 that are heterogeneous or asymmetric to another processor unit 1502 in the electronic device 1500. There can be a variety of differences between the processing units 1502 in a system in terms of a spectrum of metrics of merit including architectural, microarchitectural, thermal, power consumption characteristics, and the like. These differences can effectively manifest themselves as asymmetry and heterogeneity among the processor units 1502 in the electronic device 1500.

In some embodiments, the electronic device 1500 may include a communication component 1512 (e.g., one or more communication components). For example, the communication component 1512 can manage wireless communications for the transfer of data to and from the electronic device 1500. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1512 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1512 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1512 may operate in accordance with other wireless protocols in other embodiments. The electronic device 1500 may include an antenna 1522 to facilitate wireless communications and/or to receive other wireless communications (such as AM or FM radio transmissions).

In some embodiments, the communication component 1512 may manage wired communications, such as electrical, optical, or any other suitable communication protocols (e.g., IEEE 802.3 Ethernet standards). As noted above, the communication component 1512 may include multiple communication components. For instance, a first communication component 1512 may be dedicated to shorter-range wireless communications such as Wi-Fi or Bluetooth, and a second communication component 1512 may be dedicated to longer-range wireless communications such as global positioning system (GPS), EDGE, GPRS, CDMA, WiMAX, LTE, EV-DO, or others. In some embodiments, a first communication component 1512 may be dedicated to wireless communications, and a second communication component 1512 may be dedicated to wired communications.

The electronic device 1500 may include battery/power circuitry 1514. The battery/power circuitry 1514 may include one or more energy storage devices (e.g., batteries or capacitors) and/or circuitry for coupling components of the electronic device 1500 to an energy source separate from the electronic device 1500 (e.g., AC line power).

The electronic device 1500 may include a display device 1506 (or corresponding interface circuitry, as discussed above). The display device 1506 may include one or more embedded or wired or wirelessly connected external visual indicators, such as a heads-up display, a computer monitor, a projector, a touchscreen display, a liquid crystal display (LCD), a light-emitting diode display, or a flat panel display.

The electronic device 1500 may include an audio output device 1508 (or corresponding interface circuitry, as discussed above). The audio output device 1508 may include any embedded or wired or wirelessly connected external device that generates an audible indicator, such speakers, headsets, or earbuds.

The electronic device 1500 may include an audio input device 1524 (or corresponding interface circuitry, as discussed above). The audio input device 1524 may include any embedded or wired or wirelessly connected device that generates a signal representative of a sound, such as microphones, microphone arrays, or digital instruments (e.g., instruments having a musical instrument digital interface (MIDI) output). The electronic device 1500 may include a Global Navigation Satellite System (GNSS) device 1518 (or corresponding interface circuitry, as discussed above), such as a Global Positioning System (GPS) device. The GNSS device 1518 may be in communication with a satellite-based system and may determine a geolocation of the electronic device 1500 based on information received from one or more GNSS satellites, as known in the art.

The electronic device 1500 may include other output device(s) 1510 (or corresponding interface circuitry, as discussed above). Examples of the other output device(s) 1510 may include an audio codec, a video codec, a printer, a wired or wireless transmitter for providing information to other devices, or an additional storage device.

The electronic device 1500 may include other input device(s) 1520 (or corresponding interface circuitry, as discussed above). Examples of the other input device(s) 1520 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1500 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a display device (e.g., monitor, television), a set-top box, an entertainment control unit, a video game console, a video playback device, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1500 may be any other electronic device that processes data. In some embodiments, the electrical device 1500 may comprise multiple discrete physical components. Given the range of devices that the electrical device 1500 can be manifested as in various embodiments, in some embodiments, the electrical device 1500 can be referred to as a computing device or a computing system.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. Further, it should be understood that the various embodiments shown in the figures are illustrative representations and are not necessarily drawn to scale.

Moreover, the illustrations and/or descriptions of various embodiments may be simplified or approximated for ease of understanding, and as a result, they may not necessarily reflect the level of precision nor variation that may be present in actual embodiments. For example, while some figures generally indicate straight lines, right angles, and smooth surfaces, actual implementations of the disclosed embodiments may have less than perfect straight lines and right angles, and some features may have surface topography or otherwise be non-smooth, given real-world limitations of fabrication processes. Similarly, illustrations and/or descriptions of how components are arranged may be simplified or approximated for ease of understanding and may vary by some margin of error in actual embodiments (e.g., due to fabrication processes, etc.).

Unless otherwise specified, the use of the ordinal adjectives “first,” “second,” and “third,” etc., to describe a common object, merely indicate that different instances of like objects to which are being referred and are not intended to imply that the objects so described must be in a given sequence, either temporally, spatially, in ranking or in any other manner.

The terms “substantially,” “close,” “approximately,” “near,” and “about,” generally refer to being within +/−10% of a target value (unless otherwise specified). Similarly, terms describing spatial relationships, such as “perpendicular,” “orthogonal,” or “coplanar,” may refer to being substantially within the described spatial relationships (e.g., within +/−10 degrees of orthogonality).

Certain terminology may also be used in the foregoing description for the purpose of reference only, and thus are not intended to be limiting. For example, terms such as “upper,” “lower,” “above,” “below,” “bottom,” and “top” refer to directions in the drawings to which reference is made. Terms such as “front,” “back,” “rear,” and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

The terms “over”, “between”, “adjacent”, “to”, and “on” as used herein may refer to a relative position of one layer or component with respect to other layers or components. For example, one layer “over” or “on” another layer, “adjacent” to another layer, or bonded “to” another layer may be directly in contact with the other layer or may have one or more intervening layers. One layer “between” layers may be directly in contact with the layers or may have one or more intervening layers.

The meaning of “a,” “an,” and “the” include plural references. The meaning of “in” includes “in” and “on.”For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

Views labeled “cross-sectional”, “profile” and “plan” correspond to orthogonal planes within a cartesian coordinate system. Thus, cross-sectional and profile views are taken in the x-z plane, and plan views are taken in the x-y plane. Typically, profile views in the x-z plane are cross-sectional views. Where appropriate, drawings are labeled with axes to indicate the orientation of the figure.

The term “package” generally refers to a self-contained carrier of one or more dice, where the dice are attached to the package substrate, and may be encapsulated for protection, with integrated or wire-bonded interconnects between the dice and leads, pins or bumps located on the external portions of the package substrate. The package may contain a single die, or multiple dice, providing a specific function. The package is usually mounted on a printed circuit board for interconnection with other packaged integrated circuits and discrete components, forming a larger circuit.

The term “cored” generally refers to a substrate of an integrated circuit package built upon a board, card or wafer comprising a non-flexible stiff material. Typically, a small printed circuit board is used as a core, upon which integrated circuit device and discrete passive components may be soldered. Typically, the core has vias extending from one side to the other, allowing circuitry on one side of the core to be coupled directly to circuitry on the opposite side of the core. The core may also serve as a platform for building up layers of conductors and dielectric materials.

The term “coreless” generally refers to a substrate of an integrated circuit package having no core. The lack of a core allows for higher-density package architectures, as the through-vias have relatively large dimensions and pitch compared to high-density interconnects.

The term “land side”, if used herein, generally refers to the side of the substrate of the integrated circuit package closest to the plane of attachment to a printed circuit board, motherboard, or other package. This is in contrast to the term “die side”, which is the side of the substrate of the integrated circuit package to which the die or dice are attached.

The term “dielectric” generally refers to any number of non-electrically conductive materials.

The term “metallization” generally refers to metal layers formed over and through the dielectric material of the package substrate. The metal layers are generally patterned to form metal structures such as traces and bond pads. The metallization of a package substrate may be confined to a single layer or in multiple layers separated by layers of dielectric.

The term “bond pad” generally refers to metallization structures that terminate integrated traces and vias in integrated circuit packages and dies. The term “solder pad” may be occasionally substituted for “bond pad”and may carry the same meaning.

The term “solder bump” generally refers to a solder layer formed on a bond pad. The solder layer typically has a round shape, hence the term “solder bump”.

The term “substrate” generally refers to a planar platform, which may include dielectric and/or metallization structures. The substrate may mechanically support and electrically couple one or more IC dies on a single platform, with encapsulation of the one or more IC dies by a moldable dielectric material. The substrate may include conductive bumps or pads as bonding interconnects on one or both sides. For example, one side of the substrate, generally referred to as the “die side”, may include bumps or pads for chip or die bonding. The opposite side of the substrate, generally referred to as the “land side”, may include bumps or pads for bonding the package to a printed circuit board.

The term “assembly” generally refers to a grouping of parts into a single functional unit. The parts may be separate and mechanically assembled into a functional unit, where the parts may be removable. In another instance, the parts may be permanently bonded together. In some instances, the parts are integrated together.

The terms “coupled” or “connected” means a direct or indirect connection, such as a direct electrical, optical, mechanical, magnetic, or fluidic connection between the things that are connected, or an indirect connection through one or more passive or active intermediary devices.

The term “circuit” or “module” may refer to one or more passive and/or active components that are arranged to cooperate with one another to provide a desired function. The term “signal” may refer to at least one current signal, voltage signal, magnetic signal, or data/clock signal.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a microelectronic assembly, comprising: a first optical waveguide; a second optical waveguide; and one or more passive optical components to optically couple the first and second optical waveguides, wherein the one or more passive optical components are to shift light propagation out of plane between the first and second optical waveguides, wherein the one or more passive optical components include one or more of a mirror, a grating coupler, an evanescent coupler, or a spot size converter.

Example 2 includes the microelectronic assembly of Example 1, wherein: the first optical waveguide is comprised in a first photonic integrated circuit or a first optical interposer; and the second optical waveguide is comprised in an optical fiber, an optical connector, a second photonic integrated circuit, or a second optical interposer.

Example 3 includes the microelectronic assembly of any of Examples 1-2, wherein: the first and second optical waveguides extend horizontally, wherein light propagation through the first and second optical waveguides is horizontal; and the one or more passive optical components are to shift light propagation between the first and second optical waveguides vertically.

Example 4 includes the microelectronic assembly of any of Examples 1-3, wherein the one or more passive optical components include the mirror, wherein the mirror is to reflect light at an angle of about 90 degrees.

Example 5 includes the microelectronic assembly of Example 4, wherein the one or more passive optical components further include the grating coupler, wherein the first optical waveguide and the mirror are optically coupled via the grating coupler.

Example 6 includes the microelectronic assembly of any of Examples 1-5, wherein the one or more passive optical components include the evanescent coupler.

Example 7 includes the microelectronic assembly of Example 6, wherein the one or more passive optical components further include a third optical waveguide, wherein: the evanescent coupler is over the first optical waveguide; the third optical waveguide is over the evanescent coupler; the first optical waveguide is optically coupled to the third optical waveguide via the evanescent coupler; and the third optical waveguide is optically coupled to the second optical waveguide.

Example 8 includes an integrated circuit device, comprising: a photonic die, wherein the photonic die comprises a first optical waveguide; a second optical waveguide; and one or more passive optical components to optically couple the first and second optical waveguides, wherein the one or more passive optical components are to redirect light propagation between the first and second waveguides over a surface of the photonic die.

Example 9 includes the integrated circuit device of Example 8, wherein the one or more passive optical components include one or more of: a mirror; a grating coupler; an evanescent coupler; or a spot size converter.

Example 10 includes the integrated circuit device of Example 8, wherein the one or more passive optical components include a mirror, wherein the mirror is to reflect light at an angle of about 90 degrees.

Example 11 includes the integrated circuit device of Example 10, wherein the one or more passive optical components further include a grating coupler, wherein the first optical waveguide and the mirror are optically coupled via the grating coupler.

Example 12 includes the integrated circuit device of Example 8, wherein the one or more passive optical components include an evanescent coupler.

Example 13 includes the integrated circuit device of Example 12, wherein the one or more passive optical components further include a third optical waveguide, wherein: the evanescent coupler is over the first optical waveguide; the third optical waveguide is over the evanescent coupler; the first optical waveguide is optically coupled to the third optical waveguide via the evanescent coupler; and the third optical waveguide is optically coupled to the second optical waveguide.

Example 14 includes the integrated circuit device of any of Examples 8-13, further comprising a substrate over the photonic die.

Example 15 includes the integrated circuit device of Example 14, wherein the one or more passive optical components include a mirror, wherein the mirror is comprised in the substrate.

Example 16 includes the integrated circuit device of any of Examples 8-15, further comprising an optical fiber, wherein the optical fiber comprises the second optical waveguide.

Example 17 includes the integrated circuit device of Example 16, wherein the one or more passive optical components include a spot size converter, wherein the spot size converter is to convert a spot size of a light beam between the optical fiber and the first optical waveguide.

Example 18 includes the integrated circuit device of any of Examples 16-17, wherein the photonic die comprises a groove, wherein the optical fiber is coupled to the groove.

Example 19 includes the integrated circuit device of Example 18, wherein the groove has a depth of 60 microns or less.

Example 20 includes the integrated circuit device of any of Examples 8-15, further comprising an optical connector, wherein the optical connector comprises the second optical waveguide, and wherein the optical connector is to optically couple at least one optical fiber to the photonic die.

Example 21 includes the integrated circuit device of Example 20, further comprising a lens between the photonic die and the optical connector.

Example 22 includes the integrated circuit device of any of Examples 8-21, wherein the photonic die comprises a photonic integrated circuit (PIC), an optical interposer, or an optical and electrical interposer.

Example 23 includes the integrated circuit device of any of Examples 8-21, further comprising a photonic integrated circuit (PIC), wherein: the photonic die comprises the PIC; or the photonic die comprises an optical interposer, wherein the PIC is optically coupled to the optical interposer.

Example 24 includes the integrated circuit device of Example 23, further comprising at least one of: an electronic integrated circuit (EIC) to control the PIC; or an application-specific integrated circuit (ASIC), wherein the ASIC is to communicate optically via the PIC.

Example 25 includes a system, comprising: a first device, wherein the first device comprises a first array of optical waveguides; a second device adjacent to the first device, wherein the second device comprises a second array of optical waveguides; and a plurality of passive optical components to shift light propagation out of plane between the first array of optical waveguides and the second array of optical waveguides, wherein the first array of optical waveguides and the second array of optical waveguides are optically coupled via the passive optical components.

Example 26 includes the system of Example 25, wherein the passive optical components include one or more mirrors, one or more grating couplers, one or more evanescent couplers, or one or more spot size converters.

Example 27 includes the system of any of Examples 25-26, wherein: the first device is a first integrated circuit device; and the second device is a second integrated circuit device.

Example 28 includes the system of any of Examples 25-26, wherein: the first device is an integrated circuit device; and the second device is an optical connector, wherein the optical connector is to optically couple a fiber array unit to the integrated circuit device.

Example 29 includes the system of any of Examples 25-28, further comprising a microlens array between the first device and the second device.

1. A microelectronic assembly, comprising:
a first optical waveguide;
a second optical waveguide; and
one or more passive optical components to optically couple the first and second optical waveguides, wherein the one or more passive optical components are to shift light propagation out of plane between the first and second optical waveguides, wherein the one or more passive optical components include one or more of a mirror, a grating coupler, an evanescent coupler, or a spot size converter.

2. The microelectronic assembly of claim 1, wherein:
the first optical waveguide is comprised in a first photonic integrated circuit or a first optical interposer; and
the second optical waveguide is comprised in an optical fiber, an optical connector, a second photonic integrated circuit, or a second optical interposer.

3. The microelectronic assembly of claim 1, wherein:
the first and second optical waveguides extend horizontally, wherein light propagation through the first and second optical waveguides is horizontal; and
the one or more passive optical components are to shift light propagation between the first and second optical waveguides vertically.

4. The microelectronic assembly of claim 1, wherein the one or more passive optical components include the mirror, wherein the mirror is to reflect light at an angle of about 90 degrees.

5. The microelectronic assembly of claim 4, wherein the one or more passive optical components further include the grating coupler, wherein the first optical waveguide and the mirror are optically coupled via the grating coupler.

6. The microelectronic assembly of claim 1, wherein the one or more passive optical components include the evanescent coupler.

7. An integrated circuit device, comprising:
a photonic die, wherein the photonic die comprises a first optical waveguide;
a second optical waveguide; and
one or more passive optical components to optically couple the first and second optical waveguides, wherein the one or more passive optical components are to redirect light propagation between the first and second waveguides over a surface of the photonic die.

8. The integrated circuit device of claim 7, wherein the one or more passive optical components include one or more of:
a mirror;
a grating coupler;
an evanescent coupler; or
a spot size converter.

9. The integrated circuit device of claim 7, further comprising a substrate over the photonic die.

10. The integrated circuit device of claim 9, wherein the one or more passive optical components include a mirror, wherein the mirror is comprised in the substrate.

11. The integrated circuit device of claim 7, further comprising an optical fiber, wherein the optical fiber comprises the second optical waveguide.

12. The integrated circuit device of claim 11, wherein the one or more passive optical components include a spot size converter, wherein the spot size converter is to convert a spot size of a light beam between the optical fiber and the first optical waveguide.

13. The integrated circuit device of claim 11, wherein the photonic die comprises a groove, wherein the optical fiber is coupled to the groove.

14. The integrated circuit device of claim 7, further comprising a photonic integrated circuit (PIC), wherein:
the photonic die comprises the PIC; or
the photonic die comprises an optical interposer, wherein the PIC is optically coupled to the optical interposer.

15. The integrated circuit device of claim 14, further comprising at least one of:
an electronic integrated circuit (EIC) to control the PIC; or
an application-specific integrated circuit (ASIC), wherein the ASIC is to communicate optically via the PIC.

16. A system, comprising:
a first device, wherein the first device comprises a first array of optical waveguides;
a second device adjacent to the first device, wherein the second device comprises a second array of optical waveguides; and
a plurality of passive optical components to shift light propagation out of plane between the first array of optical waveguides and the second array of optical waveguides, wherein the first array of optical waveguides and the second array of optical waveguides are optically coupled via the passive optical components.

17. The system of claim 16, wherein the passive optical components include one or more mirrors, one or more grating couplers, one or more evanescent couplers, or one or more spot size converters.

18. The system of claim 16, wherein:
the first device is a first integrated circuit device; and
the second device is a second integrated circuit device.

19. The system of claim 16, wherein:
the first device is an integrated circuit device; and
the second device is an optical connector, wherein the optical connector is to optically couple a fiber array unit to the integrated circuit device.

20. The system of claim 16, further comprising a microlens array between the first device and the second device.
